(19) United States
(12) Patent Application Publication
(10) Pub. No.: US 2024/0026102 A1
(43) Pub. Date: Jan. 25, 2024

(54) RECYCLING OF FIBER REINFORCED THERMOSET AND THERMOPLASTIC COMPOSITES AND PREPEGS USING SOLVENTS AND CATALYSTS

(71) Applicant: WEST VIRGINIA UNIVERSITY BOARD OF GOVERNORS ON BEHALF OF WEST VIRGINIA UNIVERSITY, Morgantown, WV (US)

(72) Inventors: Rakesh Gupta, Morgantown, WV (US); Hota GangaRao, Morgantown, WV (US)

(21) Appl. No.: 18/245,265

(22) PCT Filed: Sep. 16, 2021
(86) PCT No.: PCT/US2021/071488

§ 371 Date: Mar. 14, 2023

Related U.S. Application Data
(60) Provisional application No. 62/706,914, filed on Sep. 17, 2020.

(51) Int. Cl. C08J 5/24; C08J 11/24

(52) U.S. Cl. CPC C08J 5/244; C08J 11/24; C08J 2363/00; C08J 2375/04

(57) ABSTRACT

This invention provides methods of recycling or remanufacturing a fiber-reinforced thermosetting composite including softening of a fiber-reinforced thermosetting by subjecting the composite to a partial solvolysis, and reshaping the softened composite to form a reshaped softened composite, and infusing the reshaped softened composite with a virgin thermosetting resin or a glass or other fiber wrapping to form a recycled or a remanufactured composite. Recycled and remanufactured composite(s) are provided.

### CROSS-REFERENCE TO RELATED APPLICATION

This utility non-provisional patent application claims the benefit of priority to PCT Patent Application Serial No. PCT/US2021/071488, filed on Sep. 16, 2021, which claims priority to U.S. Provisional Patent Application Ser. No. 62/706,914, filed on Sep. 17, 2020. The entire contents of PCT Patent Application Serial No. PCT/US2021/071488 and U.S. Provisional Patent Application Ser. No. 62/706,914 are incorporated by reference into this utility non-provisional patent application as if fully rewritten herein.

### STATEMENT REGARDING FEDERALLY SPONSORED RESEARCH OR DEVELOPMENT

(Not applicable)

### BACKGROUND OF THE INVENTION

### 1. Field of the Invention

This invention provides novel methods for recycling and remanufacturing of fiber-reinforced thermosetting-polymer composites and thermoplastic composites.

### 2. Brief Description of the Background Art

Polymer composites made of thermoset resins are used in wide ranging areas such as infrastructure, aerospace, green energy, sports and electronics applications. They are being advanced to attain optimal strength and stiffness to weight ratios, since their initial high-volume applications in the early 1950s. For example, thermoset composites were introduced originally as structural components in the form of underground storage tanks for petroleum products, recreational boats on the high-seas and even as reinforcing bars in concrete structural systems. Beginning in the 1970s, these advancements have continued with the application of thermoset composites to windmill blades, cooling towers for coal-fired electric power industry, recreational gadgets (skies, skate boards, sail boats), airplanes, spacecrafts and many others. Additional high-volume applications of polymer composites being implemented are in hydraulic structural systems and fenestration products (windows, doors, skylights, etc.). In many of the outdoor applications (guard rails, posts, and spacer blocks), core materials made of composite foams or low-grade core with high-grade shell have been playing an important role because of the need for better mechanical properties, durability, non-conductivity, weatherability, economic viability and others. The early applications of thermoset composites of the 1970s and 1980s either have served their useful service life, or are nearing the end of their service life. Additionally, thermoset composites industry has been generating substantial amount of waste either in production or in fabrication of composite parts. Therefore, composites manufacturers are looking for ways to economically recycle thermoset composites without resorting to landfilling or burning the composite waste.

Fiber-reinforced polymer composites made with fabrics/fibers and thermosetting polymer matrices are stronger than steel and higher grade carbon composites are even stiffer than steel. As a result, they are not easy to recycle or reuse in other applications. The approaches being tried today are (i) Grind the composite and use it as a filler, (ii) Grind the composite and burn it as fuel, or (iii) Dissolve the thermoset polymer using a solvent and recover and reuse the fibers. Approach (i) is expensive and adds little value; hence cannot cope with the volumes of materials that need to be recycled. Approach (ii) is environmentally unacceptable. Approach (iii) is expensive and is useful only when the reinforcement is carbon fibers and the residue can be hazardous and requires expensive treatment before disposal; it is not economically viable with glass fibers. Even when dealing with carbon fibers, the recovered fibers are wrinkled rather than straight. This makes fiber reuse challenging.

Polymers can be characterized as thermoplastics or thermosets. While thermoplastics can be melted and reprocessed multiple times, thermosets do not melt upon heating once they have been formed. Thermoplastics are further divided into addition polymers and condensation polymers; the latter can be easily depolymerized back to their starting components, but the former cannot be easily reduced to their monomers. Thermosets makes up roughly 20% of all polymer production, and the major thermosets are epoxy, unsaturated polyester, vinyl ester, phenolics and polyurethane. About 1 b lbs (billion pounds) of epoxy are produced each year, and this material or its variation is the matrix in composites that are reinforced with either glass or carbon fibers. Due to their lower cost, continuous glass fibers dominate the market and find application in composites used in construction, infrastructure, automotive, water, sewage and clean energy applications. Owing mainly to better mechanical properties, continuous carbon fibers are used in aerospace, compressed natural gas storage and wrapping of infrastructure. It is estimated that the overall polymer-matrix composite market has been growing at an annual rate of about 4.9%, while the annual growth rate of thermoplastics is of the order of 0.9%.

It is desired to recycle or reuse polymers and their composites once these reach the end of their useful lives. Landfilling discarded materials is very common in the US today. However, this practice is environmentally harmful, represents a loss of embodied energy and results in a waste of natural resources. Ideally, one wishes to reprocess a discarded item back into the original application. This is called primary recycling. Due to the fact that thermoplastics can be melted easily, beverage bottles made of polyethylene terephthalate (PET) are converted back to PET bottles. One may also carry out secondary recycling. Here, one reprocesses discarded plastics into a different and (usually) less demanding product. This is again common with thermoplastics. An example is the conversion of polyethylene bottles and bags into garbage bags. Both these examples represent “mechanical” recycling as opposed to “chemical” recycling. In chemical recycling, one depolymerizes the polymer into its monomers, purifies them and reuses them to make fresh polymer. Condensation polymers, such as PET, can be recycled in this manner. This method of recycling is also called tertiary recycling.

At the present time, thermosets cannot be easily subjected to primary or secondary recycling because they cannot be reprocessed by either melting or by depolymerization to monomer. Consequently, continuous-fiber composites with thermosetting polymer matrices, whether coming from post-consumer or post-industrial sources, are disposed off by one of the following methods: (i) Grinding to a powder and using the size-reduced material as a filler during manufacturing of composites that are made of both thermosets and thermoplastics. By cutting and grinding the composite in an appropriate manner, a fraction can be obtained that is rich in polymer and a fraction that is rich in fibers. However, compounding this powder with other polymers is possible only if all the materials are compatible with each other. Even then, it is common knowledge that total demand is limited. (ii) Burning or incinerating the powder to recover energy, a procedure known as quaternary recycling. (iii) Heating the powder in the absence of air so that the polymer matrix decomposes into low molecular weight liquids and gases. These decomposed products can be used as fuel or to manufacture other chemicals provided that no toxic substances are produced. The recovered fibers are very short, but these can be used to reinforce thermoplastics by extrusion and injection molding. This method of treating waste composites is known as pyrolysis. (iv) Contacting the powder with an appropriate liquid for different lengths of time and at different temperatures and pressures with a view to dissolving the polymer matrix. The resulting liquid solution can be used as a chemical feedstock, and the short fibers can be used to reinforce thermoplastics. This method of treating waste composites is known as solvolysis. Note that in commercial recycling operations involving pyrolysis or solvolysis, the resulting fibers are considered to be the valuable product, especially carbon fibers.

Not all composite waste comes from post-consumer operations. Prepregs or ready to mold sheets that contain fibers are used during composites manufacturing. Waste is generated, and it can be as much as 20-50% of the prepreg. This is often used in lower-grade products.

In the known solvolysis process for composites, as described above, the thermosetting polymer matrix is completely dissolved and often discarded. It is the fibers that are recovered and that too if they are carbon fibers; recovery of short glass fibers is generally uneconomical. Companies using solvolysis as a recycling technology include Adherent Technologies, Panasonic Electric Works Co., SACMO, Siemens AG and Innoveox.

### SUMMARY OF THE INVENTION

A method is provided to recycle and/or remanufacture a fiber reinforced thermosetting composite or a thermoplastic composite, or combinations of a fiber reinforced thermosetting composite and a thermoplastic composite (all of which may be singularly or collectively be called a composite) comprising (1) partial solvolysis of the composite which makes the fiber reinforced thermosetting composite and/or the thermoplastic composite soft and pliable and also reduces residue generation; and (2) reshaping the softened fiber reinforced thermosetting composite and/or the softened thermoplastic composite; and (3) infusing the softened and reshaped thermosetting composite and/or the softened and reshaped thermoplastic composite with at least one virgin thermoset resin for achieving an interpenetrating network in a reformed composite.

In the method of the present invention, partial solvolysis is used to only partially soften the matrix of a fiber-reinforced polymer thermosetting composite and/or a thermoplastic composite. The goal is not to depolymerize the matrix since this weakens the composite but to only soften the matrix sufficiently such that the original fiber-reinforced polymer thermoset composite and/or the original thermoplastic composite becomes pliable (i.e. softened) and is amenable to be reshaped and in certain embodiments of this invention housed in a mold. In addition, the softening provides better bonding with other compatible polymers. The nature and amount of fresh resin and reinforcement used will depend on the mechanical property requirements and will vary depending on the final product (and certainly resin requirements will be less if original part needs to be reshaped to its original shape). Thus, if the starting fiber-reinforced polymer composite is, for example, a windmill blade, and the goal is to make residential siding, the windmill blade may be sawed to the appropriate size and then softened by partial solvolysis in a reactor. In certain embodiments of the method of this invention, the softened composite is dried and put into a mold where a resin, such as for example, a polyurethane, is infused in the presence of additional glass fiber reinforcement. Upon resin curing, the desired residential siding having the predetermined values of strength and stiffness is obtained. The fine channels made in the original composite to allow the solvent to come into contact with the matrix polymer will now facilitate resin infusion and produce an inter-penetrating network between the polyurethane and the original fiber-reinforced polymer composite (here, a thermosetting polymer composite). As a result, thermodynamic compatibility between these two polymer networks is no longer essential to form a product that is strong and stiff. In certain embodiments of this invention, if the solvolysis liquid has hydroxyl or other reactive groups, these can be used as reaction sites with the infusion resin, in this example, polyurethane, so that drying of the softened composite is not required (and composite strength may improve in relation to the original part strength, i.e., as a virgin part before service or at the time of installation-before recycling).

In one embodiment of the invention, a method for forming a recycled or remanufactured composite material is provided comprising softening of either a fiber-reinforced thermosetting composite or a thermoplastic composite, or a combination of the fiber-reinforced thermosetting composite and the thermoplastic composite by subjecting the fiber-reinforced thermosetting composite or the thermoplastic composite, or the combination of the fiber-reinforced thermosetting composite and the thermoplastic composite to a partial solvolysis, and optionally using a catalyst, and optionally using elevated temperature and elevated pressure conditions over a period of time, to form a softened fiber-reinforced thermosetting composite or a softened thermoplastic composite, or a combination of a softened fiber-reinforced thermosetting composite and a softened thermoplastic composite, and optionally washing the softened fiber-reinforced thermosetting composite or the softened thermoplastic composite, or the combination of the softened fiber-reinforced thermosetting composite and the softened thermoplastic composite with water; reshaping the softened fiber-reinforced thermosetting composite or the softened thermoplastic composite, or a combination of the softened fiber-reinforced thermosetting composite and the softened thermoplastic composite to form a reshaped softened fiber-reinforced thermosetting composite or a reshaped softened thermoplastic composite, or a combination of a reshaped softened fiber-reinforced thermosetting composite and a reshaped softened thermoplastic composite, and optionally drying the reshaped softened fiber-reinforced thermosetting composite or the reshaped softened thermoplastic composite, or a combination of the reshaped softened fiber-reinforced thermosetting composite and the reshaped softened thermoplastic composite; and infusing the reshaped softened fiber-reinforced thermosetting composite or the reshaped softened thermoplastic composite, or the combination of the reshaped softened fiber-reinforced thermosetting composite and the reshaped softened thermoplastic composite, with a virgin thermosetting resin to form a recycled or a remanufactured composite material having an interpenetrated polymer network. This method includes wherein the partial solvolysis is carried out using a solvent. In certain embodiments of this method of this invention, the solvent is one selected from the group consisting of water, an alcohol, a glycol, acetone, N-Methyl-2-pyrrolidone, and an acid, or a combination of two or more thereof. In certain embodiments of this invention, the alcohol is one selected from the group consisting of a benzyl alcohol, a methanol, an ethanol, and a propanol, or a combination of two or more thereof. In certain embodiments of this invention, the virgin thermosetting resin is polyurethane.

In another embodiment of the method of this invention as described herein, the method includes employing a pre-softening step comprising employing elevated pressures and temperatures for grafting or synthesizing by sequential or simultaneous polymerization two immiscible polymers to manufacture cross-linking polymer systems for forming interpenetrating polymer networks prior to the softening step.

In other embodiments of this invention, the methods include the solvolysis step includes subjecting the fiber-reinforced thermosetting composite or the thermoplastic composite, or the combination of the fiber-reinforced thermosetting composite and the thermoplastic composite, to an elevated temperature that is greater than room temperature (i.e. 20 degrees Centigrade) and in certain embodiments between 40 to 90 degrees Centigrade and in certain other embodiments between 90 to up to 400 degrees (or greater) Centigrade, wherein the elevated pressure is from greater than atmospheric pressure to 3000 psi and greater, and wherein the time period is from two seconds to greater than 1 minute to greater than 24 hours.

In another embodiment of the method of this invention, the method includes infusing the reshaped softened fiber-reinforced thermosetting composite or the reshaped softened thermoplastic composite, or the combination of the reshaped softened fiber-reinforced thermosetting composite and the reshaped softened thermoplastic composite using glass (or carbon, aramid or natural fibers) fiber wrapping (GF wrapping) in place of (i.e. substituted for) the virgin thermosetting resin.

Certain other embodiments of the methods of this invention include prior to subjecting the fiber-reinforced thermosetting composite or the thermoplastic composite, or a combination of the fiber-reinforced thermosetting composite and the thermoplastic composite to the partial solvolysis step, drilling holes into the fiber-reinforced thermosetting composite or the thermoplastic composite, or the combination of the fiber-reinforced thermosetting composite and the thermoplastic composite to a partial solvolysis.

In another embodiment of the method of this invention, the method includes infusing of the reshaped softened fiber-reinforced thermosetting composite or the reshaped softened thermoplastic composite, or the combination of the reshaped softened fiber-reinforced thermosetting composite and the reshaped softened thermoplastic composite, is accomplished using a vacuum assisted (or high pressure induced) resin infusion process.

A recycled or remanufactured/resized composite material is provided that is manufactured by the steps of the methods of this invention as described above and herein.

### BRIEF DESCRIPTION OF THE DRAWINGS

While various embodiments of this invention are illustrated in the drawings, the particular embodiments shown should not be construed to limit the claims. Various modifications and changes may be made without departing from the scope of the invention.

FIG. 1 shows known RTM process steps (Advani et al., 1994).

FIG. 2 shows a capillary model of a porous bed.

FIG. 3(a) shows a schematic diagram of permeability measurement equipment of radial (transient) flow (Parnas and Salem, 1993).

FIG. 3(b) shows a schematic diagram of permeability measurement equipment of one-dimensional (steady) flow (Parnas and Salem, 1993).

FIG. 4 shows an embodiment of this invention providing a schematic of the Vacuum Assisted Resin Infusion Process (VARIP) of this invention.

FIG. 5 shows a flow chart of a certain embodiment of the methods of this invention.

FIG. 6 shows an untreated FRP thermoset composite with holes or spaces placed on or within the untreated FRP thermoset composite.

FIG. 7 shows a recycled or remanufactured FRP thermoset composite of this invention after the partial solvolysis step of the methods of this invention.

### DETAILED DESCRIPTION OF THE INVENTION

This invention provides technically sound, economically viable and environmentally friendly methods of recycling thermosetting polymer composites using novel manufacturing methods, and even hybridizing recycled composites with thermoset composite shells made of virgin fibers and resins. The fiber-reinforced polymer (FRP) composites of this invention are made by reinforcing thermosetting polymers, such as epoxies, with continuous fibers made of glass, carbon or aramid. Unlike the recycling of thermoplastics (e.g. polyethylene, polypropylene) which are used to make articles such as plastic bags and milk jugs, the recycling of thermosets and especially their composites is challenging. This is because thermosets cannot be melted and reformed like thermoplastics. Therefore, thermoset polymers are recycled by: (1) by grinding and using as fillers or solid waste, (2) incineration as fuel, (3) pyrolysis or (4) by solvolysis where polymer matrix is dissolved in solvents and fibers are recovered for reuse. The last two approaches involve separating fibers from the thermoset matrix and result in significant downgrading and downcycling of the FRP composites which are generally made from high quality materials. This invention provides that FRP composites can be softened sufficiently with the help of specific solvents to allow the composite to be reshaped and repurposed into new composite parts. This invention provides for the recycling of end-of-life FRPs obtained from discarded windmill turbines into high-value building products, such as residential siding and manufacturing hybrid composites for floor systems by combining softened recycled composites with virgin composites. This invention's methods covers many types of composites that can be recycled. The process of this invention will work with all fiber-reinforced plastics. Further examples of other kind of composites that may be used in the methods of this invention are set forth below.

In addition, finding a viable method of recycling post-consumer thermoset composites is of great interest to industry and governments around the world as both the landfilling, incineration and pyrolyzing approaches carry significant environmental drawbacks in terms of ground pollution and CO₂ emissions. As a result, there is growing resistance to such practices. Our research is directed at recycling both components (matrix and fibers) of FRPs without the need of separating fibers from the matrix and then even refurbishing composites not just to their original thermo-mechanical levels of responses but to any desired level depending on the application at hand by adding reinforcement. The absence of fiber separation reduces both the complexity of the process and makes the process economically viable. In this proposal, it is proposed that FRP composites can be softened sufficiently with the help of solvents to allow the composite to be reshaped and repurposed into new composite parts. Our proof of concept experiments have demonstrated the viability of this approach. The focus of the proposed work is the recycling of end-of-life FRPs obtained from discarded windmill turbines into high-value building products, such as residential siding and manufacturing hybrid composites by combining softened recycled composites with virgin composites (or from waste composites generated fabrication of FRP structures or waste generated during manufacturing which is very high as we know it today). This invention accomplishes: (i) partial solvolysis of the thermoset matrix which makes the FRP soft and pliable, and (ii) reshaping and reforming the softened composite into new products by infusing it with virgin thermoset resin. The new shape can also be wrapped with oriented-fibers and fabrics that have been wetted with resin that is subsequently cured. The approach proposed herein is an innovative approach which will allow for the recycling of thermosets at the same levels as that of thermoplastics to make value-added products, thus contributing to sustainability and advancing circular economy. Furthermore, it is essential to generate technical information that leads to mass-manufacturing of economically viable products so that thermoset recycling can compete successfully with other manufacturing processes. This invention provides (1) partial solvolysis conditions, (2) sizing selection, (3) evaluate various thermoset resins for infusion and reforming, (4) in certain embodiments of this invention provide a vacuum assisted or high pressured infusion process, and (5) evaluate thermomechanical properties of recycled or remanufactured composites. The results of this invention provide a matrix of best conditions to be used for recycling fiber-reinforced polymer-matrix composites depending on the type and size of the component to be recycled. In addition, this invention identifies examples of products that can be manufactured using end-of-life composites.

While this invention provides a novel process for recycling of thermosets, the process of this invention of softening the polymer and then forming an inter-penetrating network will also work for the recycling of fiber-reinforced plastics made with thermoplastic polymer matrices. Thus, it will be understood by those persons skilled in the art that the process of this invention applies to matrices of both thermoplastic and thermosetting polymers. Finding a viable method of recycling post-consumer thermoset composites is of great interest to industry and governments around the world by methods other than disposal in a landfill or incineration to produce energy. Both the landfilling and incineration approaches carry significant environmental drawbacks in terms of ground pollution and CO₂ emissions. As a result, there is growing resistance to landfilling or incineration.

The methods of this invention provide an innovative approach which will allow for the recycling of thermosets at the same levels as that of thermoplastics to make value-added products, thus contributing to sustainability and advancing the circular economy. Furthermore, it is essential to generate technical information that leads to mass-manufacturing of economically viable products so that thermoset recycling can compete successfully with other manufacturing processes.

As used herein, the term “solvent” is defined as a substance that is capable of dissolving another substance (solute) to form a uniformly dispersed mixture (solution) at the molecular or ionic size level. Solvents are either polar (high dielectric constant) or non-polar (low dielectric constant). Water is the most common of all solvents, and is strongly polar. Hydrocarbon solvents are non-polar. Aromatic hydrocarbons have higher solvent power than aliphatic solvents (for example, alcohols). Other solvents, for example, but not limited to, are organic solvent groups that are esters, ethers, ketones, amines, and nitrated and chlorinated hydrocarbons.

In one embodiment of the invention, a method for forming a recycled or remanufactured composite material is provided comprising softening of either a fiber-reinforced thermosetting composite or a thermoplastic composite, or a combination of the fiber-reinforced thermosetting composite and the thermoplastic composite by subjecting the fiber-reinforced thermosetting composite or the thermoplastic composite, or the combination of the fiber-reinforced thermosetting composite and the thermoplastic composite to a partial solvolysis, and optionally using a catalyst, and optionally using elevated temperature and elevated pressure conditions over a period of time, to form a softened fiber-reinforced thermosetting composite or a softened thermoplastic composite, or a combination of a softened fiber-reinforced thermosetting composite and a softened thermoplastic composite, and optionally washing the softened fiber-reinforced thermosetting composite or the softened thermoplastic composite, or the combination of the softened fiber-reinforced thermosetting composite and the softened thermoplastic composite with water; reshaping/resizing the softened fiber-reinforced thermosetting composite or the softened thermoplastic composite, or a combination of the softened fiber-reinforced thermosetting composite and the softened thermoplastic composite to form a reshaped/resized softened fiber-reinforced thermosetting composite or a reshaped softened thermoplastic composite, or a combination of a reshaped softened fiber-reinforced thermosetting composite and a reshaped softened thermoplastic composite, and optionally drying (and sieving filler particle that are added to virgin resin) the reshaped softened fiber-reinforced thermosetting composite or the reshaped softened thermoplastic composite, or a combination of the reshaped softened fiber-reinforced thermosetting composite and the reshaped softened thermoplastic composite; and infusing the reshaped softened fiber-reinforced thermosetting composite or the reshaped softened thermoplastic composite, or the combination of the reshaped softened fiber-reinforced thermosetting composite and the reshaped softened thermoplastic composite, with a virgin thermosetting resin to form a recycled or a remanufactured composite material having an interpenetrated polymer network. This method includes wherein the partial solvolysis is carried out using a solvent. In certain embodiments of this method of this invention, the solvent is one selected from the group consisting of water, an alcohol, a glycol, acetone, N-Methyl-2-pyrrolidone, and an acid. Certain embodiments of the method of this invention include employing a combination of two or more of these solvents. In certain embodiments of this invention, the alcohol is one selected from the group consisting of a benzyl alcohol, a methanol, an ethanol, and a propanol. In certain embodiments of the method of this invention include employing two or more of the alcohols as a solvent. In certain embodiments of this invention, the virgin thermosetting resin is, for example, a polyurethane.

In another embodiment of the method of this invention as described herein, the method includes employing a pre-softening step comprising employing elevated pressures and temperatures for grafting or synthesizing by sequential or simultaneous polymerization two immiscible polymers to manufacture cross-linking polymer systems for forming interpenetrating polymer networks after the softening step.

In other embodiments of this invention, the methods include the solvolysis step includes subjecting the fiber-reinforced thermosetting composite or thermoplastic composite, or the combination of the fiber-reinforced thermosetting composite and the thermoplastic composite, to an elevated temperature that is greater than room temperature (i.e. 20 degrees Centigrade), and in certain embodiments between 40 degrees Centigrade to 90 degrees Centigrade, and up to and greater than 400 degrees Centigrade, wherein the elevated pressure is from greater than atmospheric pressure to greater than 3000 psi, and wherein the time period is from two second to 1 minute and up to and including 24 hours, or greater. It is important to note that in the process conditions for recycling thermoplastic-matrix FRPs, we would not exceed the glass transition temperature of the polymer, for example.

In another embodiment of the method of this invention, the method includes infusing (for example, with virgin or recycled resin) the reshaped softened fiber-reinforced thermosetting composite or the reshaped softened thermoplastic composite, or the combination of the reshaped softened fiber-reinforced thermosetting composite and the reshaped softened thermoplastic composite using glass or other fiber wrapping (GF wrapping) in place of (i.e. substituted for) the virgin thermosetting resin.

Certain other embodiments of the methods of this invention include prior to subjecting the fiber-reinforced thermosetting composite or the thermoplastic composite, or a combination of the fiber-reinforced thermosetting composite and the thermoplastic composite to the partial solvolysis step, drilling holes into the fiber-reinforced thermosetting composite or the thermoplastic composite, or the combination of the fiber-reinforced thermosetting composite and the thermoplastic composite to a partial solvolysis.

In another embodiment of the method of this invention, the method includes infusing of the reshaped softened fiber-reinforced thermosetting composite or the reshaped softened thermoplastic composite, or the combination of the reshaped softened fiber-reinforced thermosetting composite and the reshaped softened thermoplastic composite, is accomplished using a vacuum or high pressure assisted resin infusion process.

A recycled or remanufactured composite material is provided that is manufactured by the steps comprising softening of either a fiber-reinforced thermosetting composite or a thermoplastic composite, or a combination of the fiber-reinforced thermosetting composite and the thermoplastic composite by subjecting the fiber-reinforced thermosetting composite or the thermoplastic composite, or the combination of said fiber-reinforced thermosetting composite and the thermoplastic composite to a partial solvolysis, and optionally using a catalyst, and optionally under elevated temperature and pressure conditions over a period of time, to form a softened fiber-reinforced thermosetting composite or a softened thermoplastic composite, or a combination of a softened fiber-reinforced thermosetting composite and a softened thermoplastic composite, and optionally washing the softened fiber-reinforced thermosetting composite or the softened thermoplastic composite, or the combination of the softened fiber-reinforced thermosetting composite and the softened thermoplastic composite with water; reshaping the softened fiber-reinforced thermosetting composite or the softened thermoplastic composite, or the combination of the softened fiber-reinforced thermosetting composite and the softened thermoplastic composite to form a reshaped softened fiber-reinforced thermosetting composite or a reshaped softened thermoplastic composite, or a combination of a reshaped softened fiber-reinforced thermosetting composite and a reshaped softened thermoplastic composite, and optionally drying the reshaped softened fiber-reinforced thermosetting composite or the reshaped softened thermoplastic composite, or the combination of the reshaped softened fiber-reinforced thermosetting composite and the reshaped softened thermoplastic composite; and infusing the reshaped softened fiber-reinforced thermosetting composite or the reshaped softened thermoplastic composite, or the combination of the reshaped softened fiber-reinforced thermosetting composite and the reshaped softened thermoplastic composite, with a virgin thermosetting resin to form a recycled or a remanufactured composite material having an interpenetrated polymer network. The recycled or remanufactured composite material is made wherein the partial solvolysis is carried out using a solvent. The recycled or remanufactured composite material made wherein the solvent is one selected from the group consisting of water, an alcohol, a glycol, acetone, N-Methyl-2-pyrrolidone, and an acid. The recycled or remanufactured composite material made wherein the alcohol is one selected from the group consisting of a benzyl alcohol, a methanol, an ethanol, and a propanol. The recycled or remanufactured composite material made wherein the virgin thermosetting resin is polyurethane.

The recycled or remanufactured composite material made wherein the solvolysis step includes subjecting the fiber-reinforced thermosetting composite or the thermoplastic composite, or the combination of the fiber-reinforced thermosetting composite and the thermoplastic composite, to an elevated temperature that is between 90 to 400 degrees centigrade and an elevated pressure that is from greater than atmospheric pressure to 3,000 psi, and greater pressure and a time period that is from two seconds to a 1 minute to 24 hours, or greater.

The recycled or remanufactured composite material made by infusing the reshaped softened fiber-reinforced thermosetting composite or the reshaped softened thermoplastic composite, or the combination of the reshaped softened fiber-reinforced thermosetting composite and the reshaped softened thermoplastic composite using glass fiber wrapping in place of the virgin thermosetting resin.

The recycled or remanufactured composite material made by infusing the reshaped softened fiber-reinforced thermosetting composite or the reshaped softened thermoplastic composite, or the combination of the reshaped softened fiber-reinforced thermosetting composite and the reshaped softened thermoplastic composite using a vacuum assisted resin infusion process.

In one embodiment of this invention, we soften the composite by the use of an appropriate nonhazardous liquid (e g. solvent). We have identified the liquid(s) and temperature and pressure levels needed to soften a given composite of different fiber/matrix combinations. After the original composite is softened, we do not separate the fibers from the matrix. Instead, we infuse another resin into the softened composite after putting the softened composite into a mold to reshape it, if necessary. The infused resin that is compatible or incompatible with the softened resin from recycle composite sample is then cured, and the result is an interpenetrating network (IPN). This new formed recycled or remanufactured product is itself a composite. This process, by itself, gives a new part suitable for many applications. However, we have also shown that we can add additional fiber/fabric reinforcement before the curing step and thus enhance thermo-mechanical properties of the new composite to any desired level. This gives the process great flexibility to work with any fiber and resin and to create new parts with required properties. The process is both environmentally benign and economically competitive with other ways of making composites for the same application. It can easily be adopted for large-scale recycling of composites coming from any application.

Polymers are used in construction, clothing, the energy sector, transportation and many other areas. Global polymer production is about 359 million tons/year, with polyethylene being the highest volume (at 27%) polymer produced (Senet, 2019). Low-density polyethylene grocery bags, Polyethylene terephthalate beverage bottles and polypropylene food containers constitute “single-use plastics”, but they can be mechanically recycled by shredding and reprocessing as these polymers are “thermoplastic”. Recycling is possible because these polymers can be repeatedly melted and solidified. One concern is that post-consumer polymers are commingled with each other, and the presence of impurities degrades mechanical properties. However, in their previous work, Gupta and GangaRao showed that thermoplastics could be recycled into a very large number of high-value products in a cost-effective manner without the need for plastics separation or impurity removal. This research was funded by the U.S. Department of Energy through the project entitled, “Research, commercialization and workforce development in the polymer/electronics recycling industry”. The project lasted from November 1999 to December 2007, and research results are available in the technical literature (Vijay and GangaRao et al., 2003; Agarwal and Gupta, 2014 and references therein).

Another class of polymers is called “thermosets”. These include epoxies, phenolics, polyurethanes and unsaturated polyesters and constitute about 21% of polymers produced (Senet, 2019) worldwide and these find applications in drainage pipes, thermal insulation and roofing membranes, among others. A characteristic feature of thermosets is that they have a cross-linked structure which, once formed, remains solid, and it does not melt and flow upon heating, although it can chemically degrade. Most importantly, thermosets are used as matrices in FRP composites to make windmill turbine blades, automobile parts, compressed gas cylinders, sporting goods and modern-day aircraft, such as Boeing's Dreamliner, for example. A typical FRP consists of a thermoset matrix, such as epoxy, vinyl ester or polyurethane, reinforced with glass or carbon fibers. There are many advantages that FRPs have over traditional materials such as steel. Depending upon the constituent material types (for example, glass versus carbon fiber), thermoset composites can provide two to ten times better performance than steel even though they are about four times lighter than steel. Hence, there is widespread use of FRPs in engineering applications dealing with renewable energy, automobile and aerospace industries. Indeed, the global thermoset composite market is projected to grow from about $47.8 billion to about $80.81 billion by 2026, with accompanying increase in plastic waste (Chemicals and Materials Report, 2019). Increased restrictions on waste disposal in landfills around the world and a ban on plastic waste import by countries such as China have led to great urgency in developing recycling methods for thermoset composites by industry and other stakeholders.

It is common practice to grind FRPs and use the ground material as a filler to make other lower-value polymer composites (Pascault and Williams, 2018). However, there is only a limited amount of ground material needed for reuse, and its economic value is very low. Thermoset composites may also be incinerated in order to produce energy, but this is not desirable from an environmental standpoint. Current research is focused on recovering the reinforcing fibers either by solvolysis (wet chemical polymer breakdown of the matrix) or high-temperature pyrolysis wherein the composite is subjected to high temperatures in the absence of air or oxygen (Ibarra, 2018). In both cases, the polymer matrix is removed, while the fibers are recovered and reused. The state-of-the-art research in pyrolysis is being done by the American Composites Manufacturers Association (ACMA), Oak Ridge National Laboratory and several industry partners to recycle fiber-reinforced polymers coming from automobile and wind turbine applications. The composites are shredded into 2″×2″ squares and then controlled pyrolysis is employed to remove the matrix and recover the carbon or glass fibers. These fibers are then compounded with thermoplastics and used to make reinforced plastic parts that require high stiffness as well as thermal resistance. Given that wind turbine blades can range from 100′-250′ long, shredding them into 4″ squares is energy intensive, expensive and time consuming. Finally, the recovered chopped fibers do not have mechanical properties that are as good as those of virgin long fibers. Ultimately this represents only partial recycling as only fibers are recycled, even though the volume of the matrix polymer is comparable to the volume of fibers. Clearly, another approach is needed where both the thermoset matrix and the embedded fibers can be recycled and reused. This is the innovation of the work proposed herein.

The present inventions innovation is directed at recycling both components (matrix and fibers) of FRPs without the need of separating fibers from the matrix and even refurbishing composites to their original thermo-mechanical levels of responses or to higher values depending on the application at hand. The elimination of fiber separation from the matrix reduces both the complexity of the process and makes the process economically viable. Similarly, novel manufacturing approaches using vacuum assisted resin infusion process (VARIP) and compression induced VARIP with pulsating effects are set forth to enhance mechanical properties of finished composites. The following two broad steps are enunciated herein before elaborating the detailed objectives as given in the subsequent section: (1) Partial solvolysis of the thermoset matrix which makes the FRP soft and pliable, and (2) Reshaping and reforming the softened composite into new products by infusing it with virgin thermoset resin forming interpenetrating polymer networks (IPN). The new shape can also be wrapped with oriented-fibers and fabrics that have been wetted with resin that is subsequently cured. Composite shredding and fiber separation are not required, and this approach results in little waste being produced. Note that if one is working with a large composite, the softened FRP can be delaminated into smaller sections for ease of reshaping into new value-added products. Alternately, the large composite can be cut into smaller sections and then softened; this reduces the time required for the softening step.

Solvolysis is essentially a thermochemical process in which FRP composite is treated with a solvent at elevated temperature conditions. Interaction of solvent and polymer results in complete dissolution and depolymerization of the polymer matrix from which the fibers can be separated. The dissolved polymer is a mixture of many different low molecular weight organic liquids which vary in their molecular structure. Some of them, after further processing can be used as raw materials for making new products or can be used as fuel. Generally, the solvolysis process is carried out at temperatures (from about 150-200° C.) much lower than that are used in pyrolysis, and consequently the reinforcing fibers are not thermally degraded to the same extent and higher quality recycled fibers can be obtained. Based on the solvent being used, the solvolysis can be termed as hydrolysis, alcoholysis, glycolysis, or acid digestion.

Processing conditions, in terms of temperature, pressure and time, depend on nature of solvents being used. For some solvents, high temperature and high pressure conditions are required whereas for some harsh solvents, dissolution can be achieved under rather mild conditions. For example Xu et al., (2013) dissolved epoxy matrix of a carbon fiber reinforced plastic (CFRP) using hydrogen peroxide and dimethyl formamide (DMF) at 90° C. in only 30 minutes. On the other hand, a temperature of 400° C. and reaction time of about 4 hours was needed to dissolve epoxy matrix using water as the solvent (Ibarra et al., 2015). The solvolysis process can be greatly accelerated in the presence of catalysts such as sodium or potassium hydroxide where dissolution can occur in as little as 30 minutes (Asmatulu et al., 2014). Kuang et al. (2018) used 1,5,7-triazabicyclo[4,4,0]dec-5-ene (TBD) as catalyst for alcoholysis of epoxy resins and showed that dissolution occurs much faster and can be achieved at lower temperatures in the presence of the catalyst. Yang et al., (2012) showed FTIR spectra of epoxy resin before and after solvolysis by polyethylene glycol. In virgin resin, epoxide peaks (972, 912 cm⁻¹) disappear whereas peaks for ester groups (1730 cm⁻¹) become visible. In solubilized epoxy, ester peaks disappear but strength of OH band becomes prominent. Moreover, it is found that diethyl glycol and triethyl glycol are less efficient than ethyl glycol in solubilizing epoxy.

The solvolysis process can be enhanced by using a mixture of solvents. For example, mixing water with ethanol, 2-propanol or acetone can reduce the solvolysis time by almost half (Oliveux et al., 2015). A comprehensive review of solvolysis of thermoset composites is given by Oliveux et al., (2015b). Vallee et al., (2004) found that for polyester composites, glycols were poor solvents, but better depolymerization by solvolysis occurred using amino alcohols and polyamines. Kao et al., (2012) depolymerized polyester composites at 350° C. in under 30 minutes using water as solvent and NaOH as catalyst to recover glass fibers.

Given the wide variety of solvents and catalysts and a range of temperature and pressure conditions that can be used for solvolysis, there is a great scope of designing a suitable solvolysis process. Solvolysis is found to be most effective for thermoset polymers containing amine-epoxy, anhydride epoxy, polyester and polyurethane linkages (Post et al., 2019).

In the present invention, we soften the composite (to be recycled) under mild conditions of temperature and pressure with an appropriate liquid that has an affinity for the matrix polymer. Ideally, this liquid would diffuse into the composite, then plasticize and swell the composite. Liquids that might accomplish this task can be identified using a solubility parameter approaches proposed by Hildebrand and Hansen (Kumar and Gupta, 2019). One recognizes that the enthalpy of mixing of polymer and solvent is given by:

ΔHₘ=Vφ₁φ₂(δ₁−δ₂)² Eq. (1)

Here, V is the total mixture volume, ø₁ and ø₂ are volume fractions and δ₁ and δ₂ are Hildebrand solubility parameters of the solvent and the polymer, respectively. The square of the solubility parameter is usually called the cohesive energy density. Its value is obtained by dividing the molar energy of vaporization by the molar volume. It is obvious that a material with a high cohesive energy density prefers its own company. It is, therefore, more difficult to dissolve as compared to a material with a low cohesive energy density.

An examination of the Eq. (1) shows that ΔH_{M} vanishes when the solubility parameters of the two components equal each other. Thus, the free-energy change on mixing is the most negative when the solubility parameters are matched. A cross-linked polymer would, therefore, swell the most when its solubility parameter equaled that of the solvent. This suggests that one ought to slightly cross-link the polymer whose solubility parameter is sought to be measured and allow it to swell in various solvents having known solubility parameters. The unknown solubility parameter is then equal to the solubility parameter of the liquid that gives rise to the maximum amount of swelling. This has been done for a large number of polymers. We can select the best solvent for a given polymer simply by finding a liquid with a solubility parameter of the same value.

A major assumption in the Hildebrand approach is that there are no specific interactions among molecules and therefore it is found to be most applicable only for non-polar, non-hydrogen-bonding solvents such as hydrocarbon liquids. When specific interactions exist, one modifies the solubility parameter to make it a vector sum of three distinct contributions: one due to hydrogen-bonding δ_{H}, another due to dipole interactions δ_{P}, and a third due to dispersive forces δ_{D}; these components are known as Hansen solubility parameters. In the absence of specific interactions, δ_{D} is essentially the same as the Hildebrand solubility parameter. Since these are the three components of the total solubility vector, the magnitude of the Hildebrand solubility parameter δ is given by:

δ=(δ_{H}²+δ_{P}²+δ_{D}²)^{1/2} Eq (2)

Values of each of the three components for different solvents have been determined based on experimental observations as well as on theoretical modeling and have been tabulated in books for a large number of solvents (Hansen, 1967; Hansen, 2017). Note that one can change these numbers in any desired direction by mixing together appropriate solvents that are miscible. Parameter values for polymers are also listed. For epoxy, for example, δ_{H}=9, δ_{P}=10.5 and δ_{D}=17.4 (Abbott, 2010).

The extent to which a liquid will interact with a polymer can be determined by calculating the “distance” defined as

R=[4(δ_{Ds}−δ_{Dp})²+(δ_{Ps}−δ_{Pp})²+(δ_{Hs}−δ_{Hp})²]^{1/2} Eq (3)

in which the subscripts s and p stand for solvent and polymer respectively. The smaller the calculated “distance”, the more likely is the chosen liquid to dissolve the polymer of interest. As the “distance” increases, the liquid may not dissolve the polymer but only swell it. For still larger values of the “distance” the liquid may not even plasticize the polymer. Thus, if one wants to completely dissolve epoxy, for example, in a liquid, one needs to search for a solvent or a mixture of solvents for which δ_{H}=9, δ_{P}=10.5 and δ_{D}=17.4.

More generally, one plots the Hansen solubility parameters for each of the liquids on Cartesian coordinates where the three axes are δ_{D}, δ_{P} and δ_{H}. It will be observed that points characterizing liquids which dissolve the polymer lie in the interior of a sphere and non-solvents lie outside the sphere. The coordinates of the center of the sphere represent the Hansen solubility parameters of the polymer being investigated. One also measures the radius of the sphere. A polymer is found to be soluble in a liquid when the magnitude of the vector difference between the two vectors representing the Hansen solubility parameters of the polymer and the liquid is less than the sphere radius. However, solvents that lie just inside the sphere, will merely swell the polymer. Also, a small radius implies that there is only a limited choice of solvents. For epoxy, the sphere radius is 8 (Abbott, 2010), and this value suggests that there is likely to be a wide range of solvents that are capable of dissolving or swelling the polymer.

An interpenetrating polymer network (IPN) is a combination of two crosslinked polymers which are interlaced but not covalently bonded with each other. Polymer compositions based on forming an IPN of two polymers is a widely used technique to obtain polymer blends that have superior properties. It is frequently used in case of thermoset polymers. Thermoset polymers such as epoxy though very stiff are also very brittle and do not have very good impact strength or damping properties. They can be mixed with rubbery polyurethanes or other elastomeric thermosets to form IPNs that have much improved impact or damping properties while retaining good stiffness. For example, Jia et al., (2013) formed IPN of epoxy with 10% VE to improve the impact properties and Chen et al., 2013 made aramid fiber composites of PU-epoxy IPN which showed improved modulus and better damping properties. Suresh and Jayakumari, (2015) made E-glass fiber composites to form FRP pipes using polyurethane (PU) and vinyl ester (VE) IPN and found that the IPN samples showed more elasticity and less crazing than vinyl ester composite.

IPNs differ from conventional polymer blends in the sense that in blends the dispersed phase polymer is distributed in the matrix as discrete droplets which range in size from nanometers to micrometers, whereas in IPNs, two polymers form co-continuous phases and are intimately dispersed with each other. Furthermore, in contrast to conventional thermoplastic blends where the starting materials are fully-formed polymers, the starting materials for IPN synthesis are monomers which are polymerized to form IPNs. Depending on the order in which the mixing and polymerization is carried out, the IPNs can be classified as simultaneous, sequential or gradient IPNs (Sterling and Hu, 2014). The research proposed here is based on the concept of sequential IPNs. In sequential IPNs, one polymer network is formed first and then the precursors of the second polymer are diffused into it and then polymerized in-situ.

In most of the cases, the two polymers remain phase separated but co-continuous across the whole volume. This is evidenced by presence of two glass transition temperatures (Tg) when measured by DSC or dynamic mechanical analysis. However, compatibilizers can be used to make the polymers miscible resulting in either appearance of a single glass transition or glass transitions becoming closer to each other. Varganici et al., (2013) synthesized IPN of PU and epoxy which showed a single Tg indicating good miscibility. Qin et al., (2007) found that for PU-VE IPN, better compatibility was obtained when in VE, styrene was substituted with ethylene acrylate. In yet another example, Kostrzewa et al., (2010) reported that PU with excess isocyanate groups resulted in better compatibility with epoxy and higher impact strength while more polyethylene glycol resulted in better flexural properties.

From the above discussion, it is concluded that there are many ways of synthesizing thermoset IPNs using a wide variety of chemistries to obtain a desired set of properties. In this invention, a modified version of synthesizing sequential IPNs will be used to reform and remold recycled FRPs. Partially solubilized FRP will be polymer 1 in which the precursors of the polymer 2 will be infused and then polymerized to obtain a reformed composite. Small holes drilled through the thickness of the composite will not only facilitate contact of the solvolysis liquid with the interior of the composite but also provide channels for resin infusion and IPN formation.

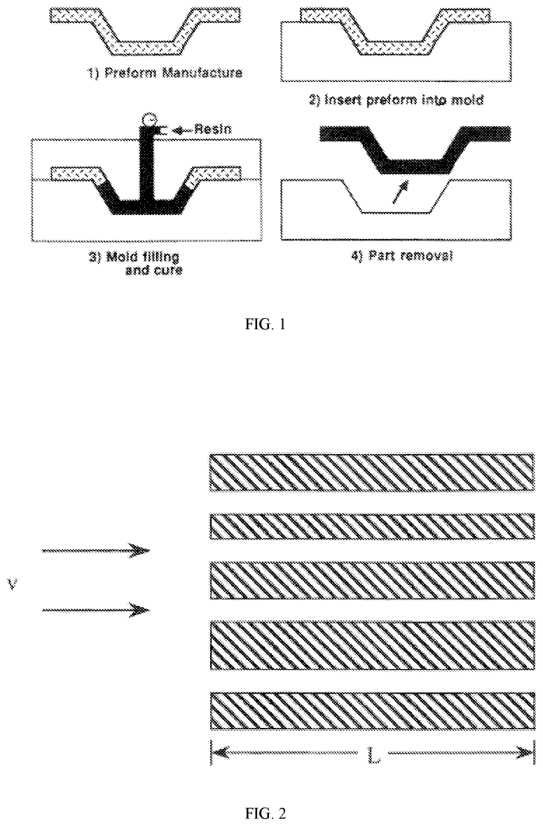

In the resin transfer molding (RTM) process, shown schematically in FIG. 1, a cold prepolymer is injected into a heated mold, where it impregnates the fiber reinforcement contained in the mold; mold-filling times are of the order of minutes (Advani et al., 1994). Curing of the polymer is initiated by heat transfer from the mold walls, and this results in the formation of the composite part. Since curing reactions are typically exothermic, resin viscosity initially decreases due to an increase in temperature, but the viscosity increases again as the polymer molecular weight increases. Consequently, curing should not begin much before the mold is filled or else premature polymer gelation can cause the resin to bypass some of the interstitial regions in the fiber preform and lead to the creation of voids and dry spots, which are undesirable. In the composites recycling process proposed here, fresh resin has to ideally flow through the recycled composite containing reinforcing fibers and the original polymer matrix. During the softening process, the original matrix is expected to become somewhat porous and develop cracks that would allow resin transfer through the composite being recycled. This is in addition to the presence of holes drilled in the end-of-life composite. Thus, the proper flow of thermosetting polymeric fluids through this material is central to the formation of an inter-penetrating network and the success of the recycling operation. FIG. 1 shows RTM process steps (Advani et al., 1994).

In RTM as well as in other similar operations, we wish to determine processing conditions that lead to uniform and complete curing of the polymer without the entrapment of gases or the occurrence of dry spots or voids, and we want to do this with as short a cycle time as possible. Many process models have been developed for this purpose, and these reveal the mold filling pattern in RTM and the temperature, pressure, and extent of cure as a function of time and position. Inputs to these models include the mathematical relation between the average fluid velocity in the porous medium and the imposed pressure gradient Δp causing the flow and also how the resin viscosity η is related to temperature and degree of cure (Collins, 1961; Springer, 1982; Loos and Springer, 1983; Advani et al., 1994). These process models are very useful in helping optimize normal composite manufacturing operations where details of the architecture of the reinforcement are available and are generally under the control of the composites manufacturer. In the present case, the structure of the recycled composite and its uniformity are not known as they depend on the beginning composite (ready for recycling) and the process conditions employed during the softening process. Thus, one needs to characterize the structure. At least initially, this needs to be done in an experimental manner. This is proposed to be done by measuring the fluid flow rate resulting from the imposition of a pressure gradient across a representative sample. This information can be supplemented by sectioning samples and observing them under a microscope.

The flow of fluids through porous materials has been considered by a very large number of authors in the past (Collins, 1961; Savins, 1969; Schiedegger, 1974; Dullien, 1979; Greenkom, 1983, for example). The simplest idealization of a porous medium is shown in FIG. 2: a solid containing cylindrical passages, each of diameter D_{eff} and length L. The resistance to flow is taken to be the same as for the actual porous medium, and this implies that, for a given pressure drop, the volumetric flow rate is the same in the two cases. Consequently, the average velocity ν_{eff} through each capillary is ν/ε, where ν is the superficial velocity which is taken to be the ratio of the volumetric flow rate to the bed cross sectional area; ε is the void fraction or porosity of uniform nature across the medium. Now, the velocity of a Newtonian liquid flowing through a tube of circular cross section is related to the pressure drop by means of the Hagen-Poiseuille equation as (see, for example, Denn, 1980):

$${v}_{eff} = \frac{{D}_{e f f}^{2} \vert Δ p \vert / L}{32 η L} \qquad Eq . ( 4 )$$

and we need to relate D_{eff}, to the geometry of the actual porous bed. This is done by requiring that the hydraulic diameter be the same in both cases. The hydraulic diameter is four times the volume available for flow divided by the total wetted surface area. For a porous bed composed of spheres of diameter D, the result is (Denn, 1980):

$${D}_{e f f} = \frac{2 ε D}{3 ( 1 - ε )} \qquad Eq . ( 5 )$$

Combining Eq. (4) and Eq. (5), we obtain an expression for the superficial velocity in terms of known quantities:

$$v = \frac{{D}^{2} {ε}^{3} \vert Δ p \vert / L}{72 η ( 1 - {ε}^{2} )} \qquad Eq . ( 6 )$$

When both sides of Eq. (6) are multiplied by the bed cross-sectional area A, we obtain the following simple expression shown in Eq. (7), called Darcy's law:

$$Q = \frac{kA \vert Δ p \vert}{η L} \qquad Eq . ( 7 )$$

in which Q is the volumetric flow rate and k is the permeability which is given by:

$$k = \frac{{D}^{2} {ε}^{3}}{72 {( 1 - ε )}^{2}} \qquad Eq . ( 8 )$$

FIG. 2 shows a capillary model of a porous bed.

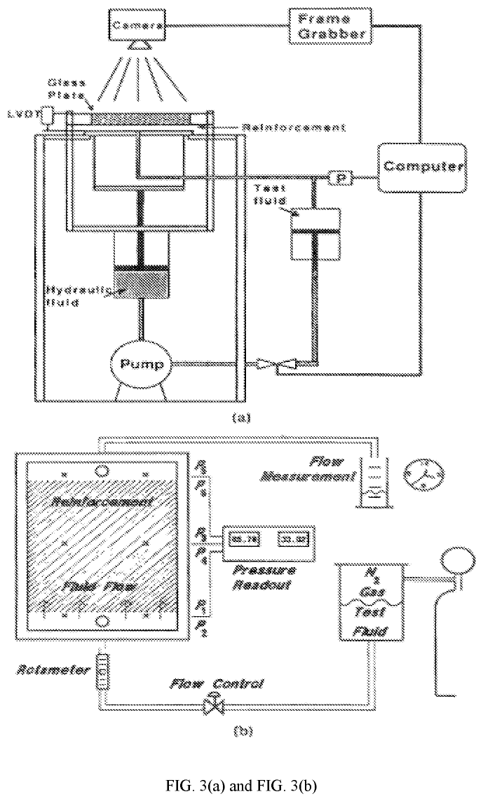

In order to measure the permeability of a porous medium, and assuming the validity of Darcy's law, we need to carry out experiments on pressure drop versus flow rate using Newtonian liquids of known viscosity. These experiments may be conducted in either a transient or a steady manner; possible experimental schemes are shown in FIG. 3 (Parnas and Salem, 1993). In FIG. 3a, liquid is injected at constant pressure or at constant flow rate into the center of the cell, and the flow is radially outwards. This flow field is meant to simulate mold filling during RTM, as illustrated earlier in FIG. 1; the mold is filled with several layers of fiber mat, each having a circular hole centered over the injection gate. In FIG. 3, liquid flows at a fixed flow rate through a cylindrical porous bed in the axial direction; this geometry simulates autoclave bag molding.

Initially, there is no fluid in the sample whose permeability is being measured. In other words, the porous bed is unsaturated, and the flow rate will change even if the injection pressure is held constant. The time that it takes for a steady state to be attained can be determined by carrying out a mass balance employing Darcy's law. In a planar geometry, this leads to the result:

$$\frac{\partial θ}{\partial t} = k \frac{{\partial }^{2}}{\partial {z}^{2}} ( \frac{Δ p}{η L} ) \qquad Eq . ( 9 )$$

in which z is the direction of fluid flow, 0 is the fluid content at any value of z and k is the permeability. Note that in the hydrology literature, Eq. (9) is known as Richards' equation.

For an isotropic, homogeneous porous medium, such as a packed bed composed of particulates, both techniques of permeability measurement should give the same permeability value. However, fiber-reinforced plastics are nonisotropic. In this instance, the permeability will be different in different directions. As a consequence, and in order to make the permeability directional, it is necessary to write the permeability as a matrix _{≈}^{K}. Eq. (7) is now rewritten as

$$\begin{matrix}v \\ \sim\end{matrix} = - \begin{matrix}K \\ \approx \end{matrix} \frac{{}_{\sim}^{∇} p}{η} \qquad Eq . ( 10 )$$

in which _{˜}^{v} is the superficial velocity and _{˜}^{∇} p is the pressure gradient. In practical terms, the resistance to fluid flow has to be measured for flow along the fibers and for flow perpendicular to the fibers.

A proper measurement of the permeability as a function of the recycling processing conditions will allow for optimum mold design including the positioning of injection gates and vents. This affects the filling phase. The curing phase is considered separately.

FIG. 3 shows a schematic diagram of permesability measurement equipment: (a) radical (transiet) flow; (b) one-dimensional (steady) flow (Parnas and salem, 1993).

### EXPERIMENTAL

Certain experiments were done with glass-fiber-reinforced epoxy coupons having a flexural strength of 2150 psi. Partial solvolysis of the epoxy was done with benzyl alcohol, and the coupon became very pliable. When solvolysis was done at 150° C. for 8 hrs, the flexural strength became 1310 psi. When the time of contact was increased to 12 hrs, the strength reduced to 180 psi. After contact at 200° C. for 18 hrs, the strength was only 94 psi. This was then infused with polyurethane, and the strength went up to 790 psi. After the addition of some glass reinforcement by wrapping during resin infusion, the strength reached a value of 2500 psi. The goal of these experiments was not to recover the strength of the composite that came from the windmill. Instead, the purpose was to demonstrate that, by changing conditions of partial solvolysis and the subsequent resin infusion and wrapping, one can obtain any desired set of mechanical properties that is relevant for the repurposed product.

A knowledge of chemical engineering principles tells us that the time of softening shall depend on the thickness of the composite that is being softened—the thicker the sample, the greater is the time required. We have shown that drilling fine holes through the thickness of the sample allows the solvolysis liquid to contact the interior of the composite rapidly, and this shortens the softening time very considerably. All these experiments were conducted at atmospheric pressure and a maximum temperature of 200° C. It is expected that increasing the temperature further and by enhancing the pressure to a few atmospheres with the use of a proper reactor will allow us to reduce the softening time from hours to minutes.

For example, we have performed experiments to validate the above approach. Small samples of glass fiber reinforced epoxy were partially solubilized using benzyl alcohol as a solvent in a pressure vessel at 200° C. (˜400° F.) for 18 hours. The resulting, partially solubilized sample was pliable and porous. As a consequence, the flexural strength of the solubilized sample was reduced to about 94 psi compared to about 2150 psi for the starting sample. In step 2, this sample was infused with polyurethane precursors and cured. The strength of the resulting composite went up to 750 psi. When the solubilized sample was wrapped with continuous glass fibers (i.e. GF wrapping) and cured, the flexural strength became as high as 2500 psi.

### Methods

This invention includes a selection of solvents for softening the used composite (i.e. an untreated old discarded composite), determination of operating conditions of time, temperature and pressure to carry out the softening, characterization of the structure and properties of the softened composite, promoting adhesion between the used reinforcement and the fresh resin through proper selection of sizing and evaluation of potential IPN, selecting the best resin system for fabricating recycled composites, carrying out resin infusion, evaluating the thermomechanical properties of the recycled components and matching these properties to the requirements of the different applications that have been identified. In view of this, certain embodiments of the methods of this invention comprise the following steps:

### 1: Determine Partial Solvolysis Conditions

This will include finding a solvent or a combination of solvents that can accomplish partial solvolysis of the composites at relatively mild conditions of time, temperature and pressure. Selection of a solvent for partial solubilization will be guided by their solubility parameters compared to the solubility parameters of the thermoset resin of recyclable composites. The selected solvent should have the ability to swell the thermoset matrix and then partially solubilize it by selectively depolymerizing some of the chemical bonds in the thermoset network. Initially, water and benzyl alcohol are proposed to be evaluated for this purpose. Our experiments show the effectiveness of, for example, benzyl alcohol in softening the FRP composites. Water has been used by many researchers for solubilizing thermosets under critical and subcritical conditions (Goto et al, 2008). Water has twin benefits of being low cost and environmentally benign. These two solvents, along with n-propanol have been identified as promising candidates in the literature (Ibarra, 2018). Values of Hansen solubility parameters for water, various organic solvents and polymers are available in literature (Krevelen and Nijenhuis, 2009; Launay et al., 2007). Expressions are also available to determine these values for a mixture of solvents and to calculate these values at higher temperatures (Krevelen and Nijenhuis, 2009). Hildebrand solubility parameter for polyester based thermosets is about 21.5 (J/cm³)^{1/2} (Deslandes et al., 1998) and for epoxy-based resins is about 23.8 (J/cm³)^{1/2} (Launay et al., 2007). It should be noted that the solubility parameters are also dependent on the chemical composition of the resins and the degree of curing (Mezzenga et al., 2000).

The solvolysis tests are performed in a high pressure stainless steel reactor. Initially, FRP samples of maximum size of about 1″×1″×6″ will be placed in the reactor and then enough amount of solvent will be added to immerse the sample. Then the reactor is sealed and will be placed in an oven at desired temperature for a desired amount of time. Alternatively, the reactor can be manufactured with temperature controls to adjust reactor temperature as needed to accelerate solvent diffusion process into thermoset composite product. The reactor is allowed to cool before taking out the sample for further examination. Conditions of time, temperature and pressure, as described later, will be varied to see their effects. In certain embodiments of the methods of this invention, the effect of sample size particularly thickness and the effect of drilling holes is evaluated for the depolymerization levels at the core of the composites, especially for higher thickness, i.e. ¾″ to 1″. Additionally, full size samples (˜18″ to 24″ width×10′ length×1″ thick) are tested in the reactor for further experimentation as discussed in steps 4 and 5 set forth below.

This is important as the solvolysis is a diffusion-controlled process. The solvent must diffuse in the sample for the solvolysis to occur. As the solvent diffuses into the sample, a concentration gradient develops and outer regions of the samples become solubilized first. Thicker the sample, longer is the time usually needed for the solvent to diffuse through the sample. An estimate of the time scale of diffusion can be made by using Fick's law of diffusion which gives the time scale of diffusion as ˜L²/D, where L is the characteristic thickness of the sample and D is the diffusion coefficient of the solvent in the composite. However, If the diffusing molecule interacts with the polymer, it can cause polymer swelling, and one can observe crazing and fracture. In addition, the diffusion coefficient becomes concentration-dependent. In the extreme case of polymer/solvent interaction that is known as case II diffusion, the sample mass is found to increase linearly with time (De Kee et al., 2005). Now if we compare two samples of different thicknesses L₁ and L₂, the time taken for the thicker sample L₂ to reach the same level of saturation by the solvent is greater by a factor of only L₂/L₁. In other words, there is constant resistance to flow that is independent of sample thickness. This is a very desirable situation for the research on recycling of relatively thick composites. Our aim will be to ensure that the sample is solubilized as much uniformly as possible across the thickness. The diffusion becomes faster at high-temperature and high-pressure conditions (i.e. greater than atmospheric pressure) and that should help in overcoming some diffusion resistance. Any rapid depressurization will create fissures in the composite producing channels for resin infusion.

In case a single solvent is not able to solubilize the FRP composites, mixture of solvents will be tested. This mixture will consist of a benign solvent such as water and a stronger co-solvent, such as benzyl alcohol. Hansen solubility parameters of various solvents will be consulted for selecting the co-solvent. Stronger solvents such as N-Methyl-2-pyrrolidone (NMP) and tetrahydrofuran (THF) ranging from 1 to 10% v are suggested for this purpose. To further accelerate the partial solubilization, catalysts are used as needed. It is known that alkali compounds such as sodium hydroxide or potassium hydroxide are effective catalysts for the solvolysis process. Generally, they are used at 0.1-0.5M concentration (Asmatulu et al., 2014) to cause complete solvolysis. Since we are only interested in partial solvolysis, a much smaller amount ˜0.01-0.05M of alkali will be used. One advantage of using such small amount would be to eliminate washing the samples to remove the unspent catalyst from the solubilized sample. Alternatively, organic catalysts such as 1,5,7-triazabicyclo[4,4,0]dec-5-ene (TBD) are evaluated. Typical temperature conditions will range from Tg of the composites to ˜300° C. The pressure will range from atmospheric pressure to 3,000 psi. Total reaction time will vary from one minute to 24 hours.

Successful completion of 1 (above) will identify the proper partial solvolysis conditions in terms of required solvent (or mixture of solvents), temperature, pressure, time and need of catalyst for composites based on various thermoset matrix materials such as epoxy, unsaturated polyester or vinyl ester.

### 2: Sizing Selection

In certain optional embodiments of this invention, sizing agents shall be used to ensure good interfacial bonding between the fiber surface and polymer matrix which is essential to obtain high stiffness and strength of the composites. Many commercial sizing agents (“sizings”) which can be used to treat glass and carbon fibers to make them more compatible with various polymers are available. Sizings are not single components but a dispersion (generally an emulsion) of several ingredients such as film-forming resin, antistatic agent, lubricant and coupling agent (Drown et al., 1991). The first three ingredients are processing aids that help during fiber production, weaving and composite manufacturing. A coupling agent helps in forming a bond between the matrix and the fiber surface. Chemically, molecules of a coupling agent consist of two segments—one segment attaches to the fiber surface and the other is compatible with the polymer matrix. Some of the most widely used coupling agents are based on organosilane chemistry. Silanes generically represented as X—Si(OR)3, contain a silanol group (—SiOH—) and an organic segment X (Thomasan, 2019). The silanol group reacts with the —SiOH— groups present on the glass surface via a condensation reaction forming a covalent bond. The organic segment, X, is generally a short chain carbon group which is either compatible with the polymer matrix or can react with the reactive groups in the polymer matrix to form permanent covalent bonds. Though many types of organosilanes are available, in the composite industry, the organic segment generally consists of epoxide, amino, methacryloxy or vinyl functionality (Thomason, 2019).

Another class of coupling agents are based on titanate and zirconate chemistry. Their structure can be represented as (RO)ₙ—Ti—(O—XR′—Y)₄₋ₙ, where R′ and Y are various organic groups and X is phosphorous. Titanate and zirconate coupling agents have several advantages over the silanes. They can be directly added into the mixture, and they do not require water to react with the surface as they react via proton chemistry than hydroxyl chemistry (Monte, 2017). Due to the presence of long organic segments with reactive groups they can participate in the polymerization reaction themselves. In these coupling agents, R′ could be isopropyl, butyl or aromatic benzyl groups that can entangle with polymer matrix and Y could be a thermosetting group such as acryl, methcryl or amino that can react with the matrix. In addition, TiO or ZiO bonds can disassociate and take part in repolymerization reaction (Elshireksi et al., 2017).

In certain embodiments of the method of this invention, silanes, are used to restore interfacial properties of the fibers that get exposed or stripped of sizing due to solvolysis. Silanes will be the sizing of choice because they are both effective and less expensive than other sizings, and they are most widely used coupling agents in the composite industry. Necessity and effectiveness of the silanes will be tested by measuring the mechanical properties of the reformed composites which should improve with their application. Amino propyltrimethylsilane (APTMS) is suggested for this purpose. Titanate and zirconate based coupling agents are also evaluated.

The goal of 2 (above) is to identify sizing type and its application procedures to restore the interface of exposed fibers of glass or carbon, in case they get damaged during partial solvolysis step (2 above), enabling the softening samples to be ready for the resin infusion process and subsequent reforming.

### 3: Evaluate Various Thermoset Curable Resins for Forming IPN

Various thermoset curable resins such as polyurethane, vinyl ester and epoxies which can be used for vacuum-assisted resin infusion and reforming of the partially solubilized composites are be evaluated. One aim would be to use the solvolysis solvent as one of the reactants in the infusion and curing process to avoid removal of excess solvent as an intermediate step.

Polyurethane resins are evaluated first for two main reasons. First, polyurethanes have been reported to be quite compatible with other thermoset resins particularly, PE, VE and epoxy (Qin et al., 2007; Kostrzewa et al., 2010; Jia et al., 2013 and Varganici et al., 2013). Secondly, various alcohols, diols and polyols which are proposed to be used as solvolysis agents can also be used as precursors in polyurethane synthesis (Janik et al., 2014). This will obviate the need to remove the excess solvent from the partially solubilized FRP sample prior to reforming and molding. Commercially available polyurethane (PU) resin packages may be used for this purpose. In addition, various epoxy and vinyl ester commercial resins specified for vacuum assisted resin molding are evaluated. Additional evaluation criteria will include viscosity and the curing profile.

Both partially solubilized samples from 1 (above) and their reactions with infusion resins will be evaluated on the basis of their mechanical properties and their ability to form Interpenetrating Polymer Networks (IPN), including curing kinetics to determine the curing temperatures and time.

The curing kinetics and glass transition behavior of various components of recycled composites will be extensively characterized using differential scanning calorimetry (DSC) and modulated differential scanning calorimetry (MDSC). DSC analyses using TA Instruments Q100 will provide information about the optimum curing temperature of various thermosets resins, curing kinetics, heat of reaction and glass transition temperatures. Isothermal and non-isothermal experiments will be performed on virgin, partially solubilized, infusion resin and recycled composites. Virgin composites are expected to reach 100% cure and high glass transition temperatures. Process of partially solubilizing the composite will cause the breakdown of the original thermoset network and that should be reflected in DSC measurements as a reduction in glass transition temperature. DSC of infusion resins will help to determine the curing temperature and time when the solubilized composite is infused with the chosen resin. DSC will also be performed on the infused samples to examine the extent of curing and glass transition temperatures. Since the infused composite will consist of two dissimilar resins (for example, polyurethane infused in vinyl ester), two glass transition temperatures should appear in the DSC analysis if they are not compatibilized or as one if miscible. MDSC will be used where regular DSC is unable to resolve the differences between various compositions.

The amount of any residual solvent in the recycled composite will be measured using TA Instruments Q500 Thermogravimetric (TGA) Analyzer. This will help determine if there is any need to remove the residual solvent by drying or to determine the amount of the residual solvent that can be used in the subsequent repolymerization step. More specifically, samples weighing about 100-200 mg will be heated up to 200° C. under nitrogen flow at 10-20° C./min heating rates. The mass of the sample will decrease as the residual solvent evaporates before leveling off. The difference between the initial and final weights will be the amount of the residual solvent that was present after the solvolysis step.

After the composite to be recycled is partially solubilized and infused with a different resin, an interpenetrating polymer network (IPN) is to be formed. Such as IPNs will be further evaluated by use of dynamic mechanical analysis (DMA, also known as dynamic mechanical spectroscopy). DMA is a powerful technique for the study of multiphase materials and characterization of the viscoelastic behavior of polymers. A sinusoidal stress is applied and the strain in the material is measured, thus determining the storage modulus and loss modulus. By varying the temperature of the sample and/or the frequency of the stress, the response corresponding to molecular motions can be limited to one type of polymers, thus revealing the structure of the IPNs. In addition, the morphology of the IPNs will be examined with transmission electron microscopy (TEM). Staining with osmium tetroxide may be needed to visualize the two different polymers if the two phases are nearly equal in electron density.

Optical and scanning electron microscopy is performed to analyze the morphology of the composite samples. This helps in determining the size and distribution of pores and voids in the partially solubilized composites. Such information will be needed in designing the infusion process so that there is near-uniform distribution of infusing resin during the vacuum assisted resin infusion process (VARIP). ImageJ® image analysis software available freely from the NIH website will be used. An optical microscope with digital camera and a Hitachi 5-4700 field-emission scanning electron microscope (FE-SEM) are available for this analysis. As the voids are expected to be spread over several order of magnitudes, microscopic examination will be performed after sectioning the samples in plane and out-of-plane directions. Morphology of the pores and voids will be examined as a function of solvolysis conditions such as solvent, temperature and time. Information about the voids will also be used in analyzing the flow of infusion resin using Richards equation. Later microscopic analysis will also be used to see if any voids or pores remain unfilled after the infusion and molding process.

Therefore, the goal of 3 (above) is to characterize the partially solubilized composites, identify the infusion resin, study curing kinetics and examine the formed IPNs.

### 4: Develop Vacuum Assisted Resin Infusion Process

After evaluating resin systems as per 3 (above), step 4 is to develop a vacuum assisted resin infusion process (VARIP) employing softened products from solvolysis (steps 1 and 2, above) that will be reinforced with glass or carbon fibers. In addition, optimum conditions for VARIP and compression molding induced VARIP will be established.

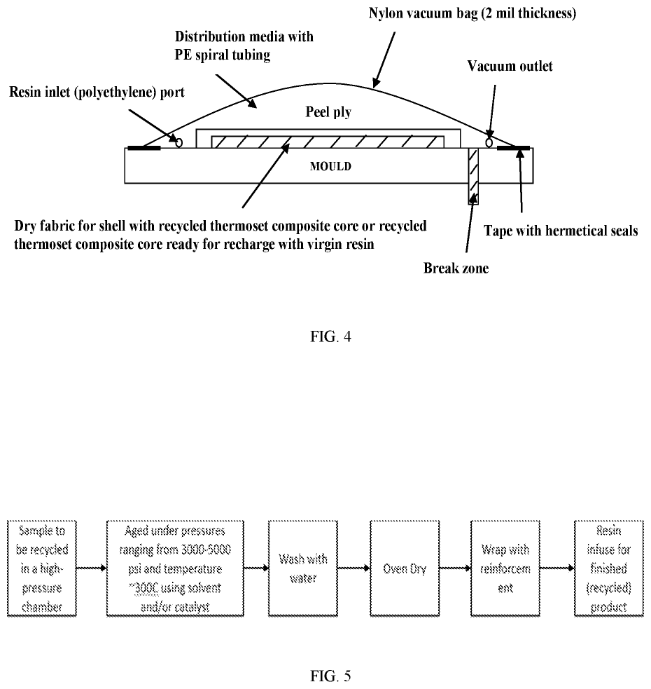

The vacuum-based resin transfer process for thermoset composite manufacturing originated in the 1950s and has taken many variations with the goal to improve thermo-mechanical qualities of composite products. Some of the improvements in the production of larger size products through infusion process are: (1) better (improved) flow media to minimize voids; (2) compaction of fabric lay-up before resin infusion to enhance fiber volume fraction under partial vacuum; (3) creating two chambers of vacuum including changing pressure levels in relation to pressure distribution along the length of a part within a part (under infusion) through “pulse infusion”; (4) others. A schematic diagram is provided in FIG. 4 for VARIP (Vacuum Assisted Resin Infusion Process). Several pressure transducers will be placed strategically to measure internal bag pressure at different locations, especially near the inlet and outlet or vent.

An excellent comparison of advantages and limitations of the varieties of VARIPs has been published recently by Van Oosterom, et al. (2019). Their focus of comparison was on the influence of process parameters such as fiber volume fraction including void content of the finished composite laminate, vacuum pressure distribution quality effects along the length of a part, process time, inlet and vent pressure combinations during both the filling and post-filling of the virgin resin, and others. Van Oosterom, et al. (2019) compared the mechanical properties (compression, tension, bending and shear strengths and moduli) of composites made of six different VARIPs. The patented Boeing method (Controlled Atmospheric Pressure Resin Infusion—CAPRI) with cyclical compaction through changing vacuum bag pressure was found to improve the mechanical properties of a composite part by increasing the fiber volume fraction at a “set” vacuum level. However, Van Oosterom, et al. (2019) found that Pulsed Infusion (PI) process with reusable silicone bag equipped with pressure pulsating device during infusion led to enhanced mechanical properties. Even though the PI process is more economical due to reusability of bagging system, the laminate thickness was found to be slightly higher (i.e., lower fiber volume fraction) than that from CAPRI process.

This step of the invention evaluates both the CAPRI and PI processes by carefully controlling the process parameters for strength and stiffness evaluations of composite laminates. The laminates in this research will be made of recycled thermoset composites as well as those made of recycled thermoset composites as core materials that are coupled with virgin composite materials as shell materials (fabric wraps around a recycled core). More specifically, the proposed VARIP process is researched in the following aspects:
a) The resin flow rate and cure kinetics will be monitored by performing experiments at (70-72° F.) and (108-112° F.). Darcy's law will be used to find flow in porous media by tracking flow front using pressure transducers, especially near the inlet and vent locations. Using equation (10), mass flow front velocity u can be expressed as below:

$$u = - \frac{k ( ∇ P )}{η} \qquad Eq . ( 11 )$$

where k is permeability which is a function of core material, void ratio as well as the fabric wrap (reinforcement) for the shell, ∇P is vacuum/injection pressure gradient, η is the material parameter (viscosity) at different resin temperatures, as well as fabric temperature during infusion process. Note that k and ∇P will be established for different scenarios by collecting data from experiments in steps 2 and 3 (above). Equations (10) and (11) are identical except that permeability is assumed isotropic for simplicity in Equation (11), which will be evaluated from pressure transducer data to be collected while conducting wide range of experiments as a part of this objective. Similarly, validity of assuming pressure gradient along the length of a part to be infused will be tested from the laboratory tests.
   b) Fabric temperature at ambient (70-72° F.) versus heated fabric (˜110° F.).
   c) Compressing dry fabric and/or recycled thermoset core at prefilling stage with and without vacuum of ˜14 psi (10 min. vs. 5 min., respectively) of dry fabric for 5 times and 10 times.
   d) Degassing resin after mixing with hardener and before filling.
   e) After saturating the part and reaching the vent, the pressure of the vent will be switched to 1-2 psi upon closing inlet vent.
   f) Post-filling cure stages: i) room temperature cure for 48 hours; ii) post-cure at 150° F. for 6 hours which follows 12 hours of ambient cure at the conclusion of VARIP.

The following is examined following experimental variations of the process:
a) Clamp the inlet before starting the infusion process to slowly reduce the pressure in the vacuum bag and build resin pressure (very slowly) between the vent and fabric in the bag; evaluate pressure gradient along the inlet—vent distance, which is typically well above 4 to 5 ft.
b) Setting pressures at inlet and outlet to be closer to each other (˜say 14 versus 5 psi) to remove excess resin accumulation near inlet and turning inlet as an outlet immediately after infusion is complete, to remove excess resin at inlet, and also vent will be switched to 1-2 psi.
c) Vary post-filling pressures (suction) with 0 and 5 psi for comparison with data from (a) and (b). This includes the pressure variations along the length of a composite part to be prepared for this proposed project.
d) Under ambient temperature conditions, repeat experiments from item (c) after establishing reasonable levels of the optimal inlet and outlet pressures for validation of experimental data, specifically in terms of void content, where void volume fraction is defined as:

$$\frac{{V}_{void}}{V} = ( \frac{{ρ}_{f}^{s}}{{ρ}_{r}^{v}} - \frac{{ρ}_{f}^{s}}{{ρ}_{f}^{v}} ) \frac{n}{h} - \frac{{ρ}_{F R P}}{{ρ}_{r}} + 1 \qquad Eq . ( 12 )$$

Where ρ_{f}^{s} and ρ_{f}^{v} are areal and volume densities of fabrics, respectively. H is the thickness of the sample, ρᵣ and ρ_{f} are volume densities of resin and fabric, respectively. n corresponds to number of fabric layers. The void volume fraction (v_{void}/v) will be compared with the data obtained from the information generated under step 3 (above). Note that the volume densities will be established as per ASTM D 192.
e) Compression induced VARIP: After placing dry fabric in a mold with a gap between the fabric and upper mold surface, the dry fabric is infused with resin when vacuum and external pressure is applied, pushing the liquid resin through the thickness of a composite part. WVU has a functional 2 ft wide by 20 ft. long heated 200-ton press, which will be employed to compress the uncured (wet) reinforced laminate to exert vertical (through the thickness of composite) pressure and enhance resin wet out and also minimize voids to attain higher uniformity in thickness along the laminate length.
f) Use the experimental data of items (a to e) to develop prediction equations for optimal infusion rate and thickness; thus minimizing voids, and even evaluate the validity of Darcy's Law as given in Eq. (11).

It is important to note that because of the removal of excess resin, especially near the inlet, the above approach (as opposed to conventional approach of clamping the inlet in the post-filling stage) would result in higher fiber volume fraction, thus enhanced mechanical properties throughout the composite part, with consistent part thickness along the part length. The void volume fraction will be decreased in the part because the pressure differential between inlet and outlet will be minimized. Removing air and minimizing the void content in the core of the composite part (primarily a fluffed and recycled core of high flexibility) is extremely important to obtain consistent mechanical properties for the final product. The most recent studies have shown that high flow resistance near the vent area can be reduced by providing a “break” (flow-resistance) near the outlet; thus enhancing “resin pressure” over the fabric reinforcement near the vent region. The location of “break” is shown in FIG. 4, near right bottom corner.

Total number of test samples prepared under this program include: (3 resin types)×(2 fabric configurations)×(3 sizings)×(2 resin temperatures)×(2 fabric temperatures)×(2 types of VARIP)×(3 variations in each VARIP type)×(3 replications)=1296

The above samples are evaluated for void volume content along the sample length and width, and its distributions, percent cure, resin rich and resin starving areas, coupon level material properties such as shear, bending, tensile and compression strengths and stiffness. The coupons will be prepared as per ASTM standards, which are identified under step 5 (below).

### 5: Evaluate the Thermomechanical Properties of the Recycled Components and Identify Applications

This invention provides for improved thermomechanical and other properties that are needed for the marketable recycled or remanufactured composites. Composite parts produced under step 4 (above) are evaluated for mechanical properties such as strength and stiffness first at coupon levels under tension (ASTM D638), compression (ASTM D6641), shear (ASTM D2344 and D5379) and bending (ASTM D790). After evaluating for coupon level properties, full size sections are prepared and tested to understand scaling anomalies of recycled thermoset composites. The select full-size samples (˜2′×10′ and ˜2′×20′) with maximum composite thickness of ¾″ to 1″ are tested for bending, shear and buckling strengths.

The full size sections that are tested are:
a) Guard rail posts and railings: 2 products×2 VARIP×3 test types×3 replicates, giving 36 tests in total. Please note that spacer blocks will not be tested herein because these were made earlier with recycled composites and are being evaluated after 14 years in service, on a major bridge near Morgantown, WV.
b) Fenestration products: These will be made from VARIP coupled with compression molding operations available at WVU. 4 products×1 VARIP×3 test types×3 replications=36 tests
c) Planks of 10′ lengths of 2 thickness: 2 processes×1 length×2 thickness×3 replications×3 test types=36 tests
d) Others: Windmill blades of 10′ with 2 processes: 1 lengths×3 test types=3 tests

The full-size samples that are tested under this program are to be considered for the following applications:
1) Guard rail posts, railing systems and spacer blocks which will be implemented by WVDOT-Division of Highways. The data will be compared with conventional wood or steel posts, wooden spacer blocks and steel rails.
2) Fenestration Products: Shutters and framing systems for windows and doors will be manufactured using compression-VARIP process and the mechanical property performance will be evaluated for comparison with conventional systems in practice. Similarly, framings for windows and doors will be made at WVU-Major Units Lab using manufacturing procedures enunciated in Objective (4).
3) Structural components such as beams, columns for cooling towers, dwellings, etc park benches deck boards will be made for test runs to determine the design capacities of these recycled composite parts. The WVU-CFC has special capabilities to apply gel coats to these products to attain aesthetically pleasing finishing.
4) Other products such as windmill blades will be made only as models (<10′ in length) to demonstrate process capability (Objective 4) to produce non-rectangular shapes.

Based on data generated, the primary theoretical evaluations of full-scale members are:
1) Strengths and stiffness under bending, shear, and axial tension
2) Integrity of bond between the virgin FRP shell material wrapped around the recycled thermoset composite core material
3) Determination of changes in slopes of stress versus strain or load versus deflection curves
4) Accelerated aging of coupons (not full-scale members) to establish moisture diffusions rates and reductions in strengths and stiffness at different temperature levels (<Tg) under varying time conditions.

Stiffness and strength evaluations: It is most likely that stiffness (axial, bending) are going to be primarily influenced by the fiber stiffness, while contribution of resin stiffness will be less than 10% of the total composite stiffness. This is established from “rules of mixture” theory. However, bending, tensile, compression and shear strengths will be dependent upon the degree of structural compositeness of virgin FRP shell with the recycled (partially flexed) thermoset composite core. The degree of structural compositeness is determined from classical theories of mechanics (Boresi and Schmidt, 2002) and many other classical failure theories on FRP composites that are well documented in literature (Kaw, 2006). Additionally, the strain energy-based theories developed by Gangarao and Dittenber (2012) as well as those developed by Gangarao and Vadlamani (2007) are employed to determine failure strengths of these materials with softer composite cores made of recycled thermoset composites. Herein, the strain energy theories take advantage of total strain energy computations with reference to the strains under different load actions to failure to determine failure strengths (bending, tension, compression, and shear) of the newly formulated material.

Since shear strengths and stiffness are more dominated by resins than other strengths, attention will be paid to the development of strain energy-based theories to determine shear strength after computing shear stiffness using rule-of-mixture.

Bond failure (if any) between the virgin FRP composite wrap and the recycled core will be established from strain gage reading under bending load conditions before extending to tensile load conditions. It is believed that core material is weaker than the shell material leading to better resisting internal (within cross section) stress distribution and in the cases of conventional composites with foam core. Again, we intend to juxtapose stronger material (virgin composite wrap) as shell which would resist higher bending and tensile stress with weaker core (recycled composite) at locations where bending stresses are lower. In terms of tensile testing, due to the “shear-lag” phenomenon, the composite shell will resist a higher percentage of the overall loading as opposed to the core. The above structural response is different under shear forces where shear due to bending loads may induce higher shear stress in the core than those in the shell materials. However, we believe that lower core shear stiffness may transfer higher shear resistance to the shell material; thus balancing the internal shear resistance in an efficient manner.

The stress versus strain or load versus deflection responses, especially of full-size members will reveal a great deal of internal working mechanism of the composites that we are proposing herein. We place gages along the width of a composite (that we manufacture in WVU labs) and use it as a specimen depth while testing under bending loads to establish the validity of strain compatibility along the beam depth (approx. 18″ to 24″) of a 10′ span plank system.

For example, we want to make sure that premature debonding of the core from virgin shell does not take place under varying thermal conditions.

This invention provides recycled and remanufactured polymer composites, including thermoset composites and thermoplastic composites, resulting in mass production of high-volume and high-value added products, such as for example, but not limited to, a) recycle rail road ties, b) deck panels, c) sidings for dwellings, and d) filler modules to strengthen structural system. This invention advances composite product manufacturing capability.

Fiber-reinforced polymer composites made with fabrics/fibers and thermosetting polymer matrices are stronger than steel and higher grade carbon composites are even stiffer than steel. As a result, they are not easy to recycle or reuse in other applications. Therefore, approximately 80% to 90% of the composite waste totaling millions of pounds of waste per year, goes in to landfills. The plastic or reinforced polymer composite waste has gone from 1% in 1960 to 12.1% in 2007. The waste disposal costs are high and they are ranging from at least $200-$250 per ton. Therefore, there is a need for a value added solution through technical innovations. The current state-of-the art of recycling of composites is based on grinding the discarded composite into finer particles and using them as filler materials in reinforced composites. However, this approach is expensive and adds little value, and therefore cannot be a solution for the volumes of materials that need to be recycled. Other approaches include grinding the composite and burning it as fuel, which has to date been found to be environmentally damaging. Another approach that has been tried is dissolving the thermoset polymer using a solvent, and recovering and reusing the fibers. However, using current technology this approach is expensive, and useful only when the reinforcement is carbon fibers; further, the residue can be hazardous and requires expensive treatment. Further, these recovered fibers are wrinkled rather than straight, making fiber reuse challenging.

Other approaches include reusing prepreg materials that have elapsed shelf-life or prepreg scraps without separating the fibers/fabrics from resin, by utilizing the chemical breakdown of polymers (sub-critical hydrolysis process) at process temperature ranges lower than the incineration range of the constituent polymers. Recovery and reuse of fibers and resins from end-of-life composites has been accomplished by weakening the crosslinking, followed by fiber separation from the depolymerized matrix in the composite. An example of this approach applied to a thermoset matrix of glass reinforced composite includes heating, pressurizing and softening the composite in the presence of benign chemical (e.g. benzyl alcohol, which is miscible with water and can be recycled) to decompose the matrix, wherein an appropriate softener and even catalysts are required to adjust both the temperature and pressure levels for a cost effective solution/process (e.g. softening the thermoset resin in a composite).

Finally, thermo-reversible resins are being developed and experimented with (not fully matured yet) so that they can be recycled into precursors under certain time-temperature-pressure (TTP) conditions, i.e., solid composites made of new family of resins at room temperature can be softened and remolded into desired shapes at intermediate temperatures ranges using solvents before curing them at higher temperatures into final and permanent shapes.

Those persons of ordinary skill in the art will understand that the methods of this invention provide a new process through novel de-polymerization of the matrix using TTP techniques, including solvents and catalysts for softening purposes, and adding compatible thermoset or thermoplastic resins for grafting and even certain reinforcement and re-polymerizing discarded composites. In the disclosed technology, the original composite being recycled (made of conventional thermoset/thermoplastic resin) is softened by the use of an appropriate nonhazardous liquid (e.g. water). Laboratory research has helped to identify certain liquid(s) and temperature and pressure levels needed to soften a given composite of different fiber/matrix combinations. After the original composite is softened, the fibers are not separated from the matrix (i.e., epoxy, vinyl ester and polyester matrices). Instead, another resin compatible or incompatible with the softened resin is infused into the softened composite after putting the softened composite into a mold to reshape it, if necessary. Using certain monomers, these bonds can be reformulated and one can obtain an interpenetrating polymer matrix. The infused composite is then cured, and the result is an interpenetrating network (IPN). This product is itself a composite. This process, by itself, gives a new part suitable for many applications. Additional fiber/fabric reinforcement can be added before the curing step and thus enhance thermo-mechanical properties of the new composite to any desired level. This gives the process great flexibility to work with any fiber and resin and to create new parts with required properties. The process is both environmentally benign and economically competitive with other ways of making composites for the same application. It can easily be adopted for large-scale recycling of composites coming from any application. More specifically, FRP composites (both thermoplastics and thermosets) are softened and swollen using techniques based on solvents such as water, acetone, CO₂, benzyl alcohol, and others such as catalysts under certain temperatures and pressure and over a period of time. Normally supercritical liquids become gas-like when the temperature and pressure exceed the “critical” temperature and “critical” pressure. A distinguishing character of supercritical liquids is their low viscosity that makes them be very effective solvents for the disclosed technology. The softening process will take place over a time period of few hours (e.g., for example but not limited to one to eight hours) and perhaps even days with/without increasing temperatures. When benzyl alcohol, for example, is used as the solvent, the temperature and pressure used in the process of the disclosed technology are much lower than critical values—thereby, benzyl alcohol is a very effective solvent in the disclosed technology; other solvents may possibly make the softening process of the composite even more efficient and cost-effective. The softened FRP composite(s) can be molded in to value-added end products using room temperature vacuum infusion processes, compression molding processes, high temperature infusion processes and other processes, depending on the intended end application for the material. Further, the disclosed technology regards grafting or blocking a copolymer, or synthesizing (sequential or simultaneous) two immiscible polymers to form Interpenetrating Polymer Networks (IPN) at elevated pressures and temperatures, to potentially arrive at cross-linking polymer systems which are different from the original (constituent) polymers, are under development. By the disclosed technology, the de-polymerization technique in the presence of solvents (and catalyst(s)), under higher temperatures and pressures may be employed to soften the polymer and reinforced composite without harmful environmental effects, before repolymerizing and reinforcing the discarded polymer or composite. The method of the disclosed technology works, for example, with carbon, glass or aramid fiber reinforcements since the solvents and temperatures of recycling do affect the base properties of resins and reinforcements. Further, the enhanced value of discarded composites include time-lapsed prepregs, will limited composite wastes going to landfills, and provide environmentally safe reformulations using materials such as water, CO₂ and others.

Preliminary analysis shows that that using benzyl alcohol as a solvent (and a catalyst if needed) to depolymerize thermoset resins is superior to using acetone as a softener of cured thermoset based fiber reinforced polymer composites. Similar solvents and catalysts are being evaluated to minimize de-polymerization time, as well as elevated temperature and pressure conditions (slightly above ambient conditions) if needed for softening of polymers and composites, and further hasten the softening process without damaging the reinforcements in composites. Based upon preliminary experimentation, thermoset composites under certain time, temperature and pressure levels and in the presence of benzyl alcohol or other solvents have lost about 80% of their original interlaminar shear strength capacity; hence they can be shaped and reshaped in to different configurations (shape) before infusing the softened composite with new resin(s) and even additional reinforcements to arrive at recycled products. This approach attained similar or higher thermo-mechanical properties as the original composite. Furthermore, the softened composite(s) exhibited superior properties under oven-dried conditions than under air-dried conditions and the search is on to find solvents (and catalysts) that would result in good thermo-mechanical properties even under ambient temperatures and air-dried conditions. It has also been found that the post-softened fiber reinforced polymer composites can be infused and cured with resins that would react with residues (original resin system residue after softening, including moisture) to result in a better product than the original composite. This step is explored even with new reinforcements and other resins, and preliminary lab results are highly promising. Further, certain types of remanufacturing processes of softened (recycled) reinforced composites such as vacuum based infusion are far more amendable and cost-effective than compression molding process to attain the best possible thermo-mechanical properties after composites are recycled.

Finally, based upon the processes of the disclosed technology, the energy inputs are not only minimal compared to the current approaches (grinding & heating) of recycling of composites, but also result in value added end products as compared to current approaches of ground composite residues which are being used as fillers. The process is not limited by the size of the composite to be recycled.

Advantages of this invention, for example but not limited to the following, are: The de-polymerization technique in the presence of solvents (and catalyst) and under higher temperatures and pressures are employed to soften the polymer and reinforced composite without harmful environmental effects before re-polymerizing and reinforcing the discarded polymer or composite; enhanced value of discarded composites are time-lapsed prepregs; no composite wastes will go to landfills; and environmentally safe reformulations using materials such as water, CO₂ and others

### Data and Results:

### Recycling Reinforced Plastics:

The disclosed technology was tested to find ways to soften FRP for purposes of recycling, as herein described. Two different test were done to soften the thermoset rein in the glass reinforced composite samples. The first batch of test samples involved using a pressurized cylinder that was heated while submerging the samples in desired chemicals such as acetone. Use of acetone was discontinued due to the deterioration of seals in the high pressure apparatus (pressure chamber). The second batch of test samples were submerged in

benzyl alcohol and heated for a fixed amount of time before testing. After the samples were tested under shear, the data was analyzed to show the strength trends of recycled composites. The first batch of test samples showed trends that samples subjected to the highest pressure, higher temperatures, for the longest time, had the lowest stress to failure. In the first batch of testing, the maximum temperatures and pressures were achieved with the apparatus (5000 psi and 300° C.), and the samples showed considerable amounts of degradation. In the second approach, samples were placed in to a high pressure cylinder which was placed in an oven and heated to a select temperature for a set of time. Herein, all samples were placed in benzyl alcohol. The testing started at a lower temp for a short duration and was tested until the samples were shown to have bond deterioration and most importantly, these samples were amenable for infusion with virgin resins to form a new sample. Like the data trends in the first set of testing, the second batch at higher temperatures and longer duration exhibited severe the polymer decomposition, which is based on short-beam shear test data.

The shear test data was compared with the data from virgin samples. After the desired amount of time and temperature were found for the second batch of tests, the samples were then infused with vinyl ester and tested under shear. Some of the samples were just infused and then tested and others had wraps applied to improve strength. The samples were washed and dried and infused with resin and/or reinforcement before conducting short-beam shear testing. Two different methods were used to remove the excess alcohol. The first method was to wash in water and air dry, the second was to wash in water and then oven dry the samples. Trends after testing showed that the samples that were oven dried were showing improved shear stresses in the recycled composites and even exceeded the shear stresses of virgin samples.

Samples Details with Peak Short-Beam Shear Stress
(psi) shown:
Virgin 1: Control samples 2150 psi
Test 7: tested with acetone and no resin infusion at 100° C. for 5 hrs (hours) 2105 psi
Test 8: tested with acetone and no resin infusion at 150° C. for 8 hrs; pressure seal was partially dissolved 1310 psi
Test 9: tested with acetone and no resin infusion at 150° C. for 12 hrs; no pressure seal was used 180 psi
Test 10: infused with VE resin at 200° C. for 18 hrs 94 psi
Test 10A: infused with VE resin and wrapped with 3 fiberglass layers (18 osy) @ 200° C. for 18 hrs 2140 psi
Test 10B: infused with VE resin and wrapped with 3 fiberglass layers (18 osy) at 200° C. for 18 hrs 1850 psi
Test 11: Virgin 1 aged at 150° C. for 12 hrs 1121 psi Virgin 2: Control sample 2347 psi
Test 13A: VE resin infused and no fiberglass at 200° C. for 18 hrs 136 psi
Test 13BR: VE resin infused and no fiberglass at 200° C. for 18 hrs 369 psi
Test 13CR: VE resin infused and no fiberglass at 200° C. for 18 hrs 360 psi
Test 14A: Washed in water and oven dried partially followed by VE resin coat at 200° C. for 18 hrs 225 psi
Test 14BR: Washed in water and oven dried partially followed by VE resin coat at 200° C. for 18 hrs 790 psi
Test 14CR: Washed in water and oven dried partially followed by VE resin coat at 200° C. for 18 hrs 734 psi
Test 15AR: Washed in water and oven dried fully followed by VE resin infused and wrapped with 3 fiberglass layers at 200° C. for 18 hrs 2524 psi
Test 15BR: Washed in water and oven dried fully followed by VE resin infused and wrapped with 3 fiberglass layers at 200° C. for 18 hrs 2403 psi
Test 15CR: Washed in water and oven dried fully followed by VE resin infused and wrapped with 3 fiberglass layers at 200° C. for 18 hrs 2489 psi Note: All the above specimens were aged at 3000 psi or lower pressures.

FIG. 5 shows an embodiment of the Recycling of Fiber Reinforced Thermoset and Thermoplastic Composites and Prepregs Using Solvents and Catalysts of this invention.

### Data on Partial Solvolysis of Glass Fiber-Reinforced Vinyl Ester Composites

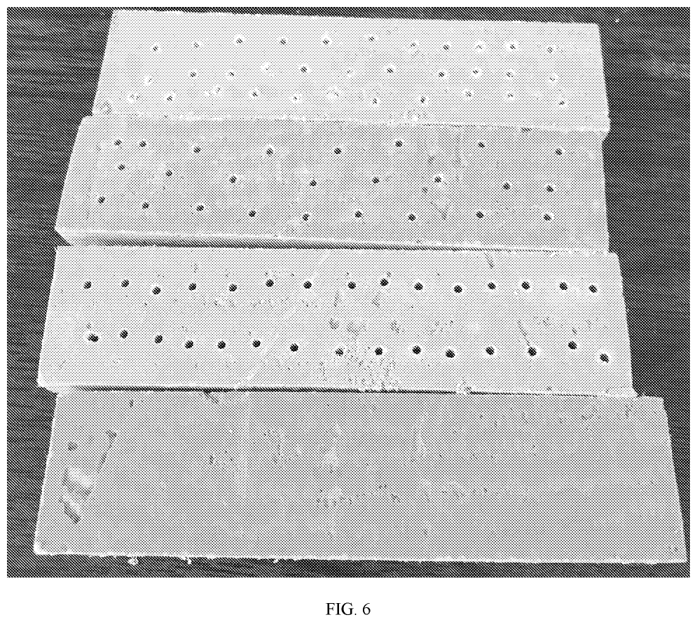

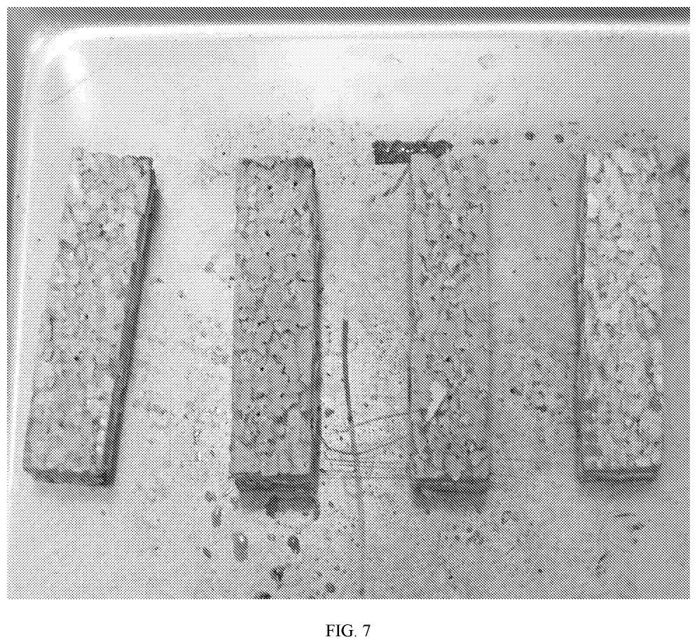

Glass-reinforced vinyl ester samples with 0-90 fibers and of two different thicknesses were used. The dimensions were 76 mm×19 mm×6.2 mm for thicker samples and 76 mm×19 mm×3.2 mm for thinner samples. These were contacted with benzyl alcohol at 200° C. and atmospheric pressure. It was found that 16 h were needed to soften the thick samples. However, the time was reduced to 7 hours by drilling 1 mm diameter holes in the samples as shown in FIG. 6. The thin samples required only 1 hour for softening in the presence of the 1 mm diameter holes. This shows the effect that sample thickness has on softening time. The application of pressure will help to reduce the softening time further. FIG. 7 shows samples after partial solvolysis according to the method of this invention. This experiment softens composite samples where the matrix polymer is a vinyl ester and where the solvolysis liquid is benzyl alcohol. This data shows the influence of sample thickness and the effect of drilling 1 mm diameter holes through the thickness of the samples.

It will be appreciated that large discarded composite parts can be softened and cut into smaller sections for ease of reshaping into new value-added products. In some cases, it may be preferable to first saw/cut a large part into a smaller part before softening. If the small part is a thin part, this procedure will reduce softening time.

### REFERENCES

Abbott, S., Chemical Compatibility of Poly(Lactic Acid): A Practical Framework using Hansen Solubility Parameters, in Poly(Lactic Acid), R. Auras, L.-T. Lim, S. E. M. Selke, and H. Tsuji (eds.), Wiley, Hoboken, N J, 2010, pp 83-95.
Advani, S. G., M. V. Bruschke, R. S. Paraas, Resin transfer molding flow phenomena in polymeric composites. In: S. G. Advani, ed. Flow and Rheology in Polymer Composites Manufacturing. Elsevier, Amsterdam, 1994, pp. 465-515.
Agarwal, S., R. K. Gupta, Recycling of Post-Consumer Engineering Thermoplastics: ABS and Polycarbonate in Recycled Polymers: Chemistry and Processing, edited by Vijay Kumar Thakur, published by Smithers Rapra, 2014.
Asmatulu, E., J. Twomey, M. Overcash, Recycling of fiber-reinforced composites and direct structural composite recycling concept, Journal of Composite Materials, 48, 593-608, 2014.
Boresi, P., R. J. Schmidt, Advanced Mechanics of Materials 6th Edition, John Wiley and Sons, 2002.
Chemical and Materials Report, Global Thermoset Composites Market—Industry Trends Forecast to 2026, April 2019, https://www.databridgemarketresearch.com/reports/global-thermoset-composites-market #.
Chen, D., K. Arakawa, C. Xu, Reduction of void content of vacuum-assisted resin transfer molded composites by infusion pressure control, Polymer Comp J., 36, 2014.
Chen, S., Q. Wang, T. Wang, Physical properties of aramid fiber reinforced castor oil-based polyurethane/epoxy resin IPN composites, Journal of Reinforced Plastics and Composites, 32, 1136-1142, 2013.
Collins, R. E., Flow of Fluids Through Porous Materials. Van Nostrand-Reinhold, Princeton, N J, 1961.
De Kee, D., Q. Liu, J. Hinestroza, Viscoelastic (non-Fickian) diffusion, Can. J. Chem. Eng., 83, 913-929, 2005.
Denn, M. M., Process Fluid Mechanics. Prentice-Hall, Englewood Cliffs, N J, 1980.
Deslandes, N., V. Bellenger, F. Jaffiol, J. Verdu, Solubility parameter of a polyester composite material, Journal of Applied Polymer Science, 69, 2663-2671, 1998.
Dittenber, D. B., H. V. S. Ganga Rao, Fatigue equation considerations for the American Society of Civil Engineers pre-standard for load and resistance factor design of pultruded fiber-reinforced polymer structures, Journal of Composite Materials, 47, 1943-1949, 2012.
Drown, E. K., H. Al Moussawi, L. T. Drzal, Glass fiber ‘sizings’ and their role in fiber-matrix adhesion, Journal of Adhesion Science and Technology, 5:10, 865-881, 1991.
Dullien, F. A. L., Porous Media: Fluid Transport and Pore Structure. Academic Press, New York, 1979.
ElShereksi, N., M. Ghazali, A. Muchtar, C. Azhari, Review of titanate coupling agents and their application for dental composite fabrication, Dental Materials Journal, 36, 539-552, 2017.
Greenkom, R. A., Flow Phenomena in Porous Media. Marcel Dekker, New York, 1983.
Goto, M., Review: Chemical recycling of plastics using sub- and supercritical fluids, J. of Supercritical Fluids, 47, 500-507, 2009.
Hansen, C. M., Hansen Solubility Parameters, CRC Press, Boca Raton, F L, 2007.
Hansen, C. M., The Three Dimensional Solubility Parameter and Solvent Diffusion Coefficient, Danish Technical Press, Copenhagen, 1967.
Ibarra, R. M., M. Sasaki, M. Goto, A. T. Quitain, S. M. G. Montes, J. A. Aguilar-Garib, Carbon fiber recovery using water and benzyl alcohol in subcritical and supercritical conditions for chemical recycling of thermoset composite materials, J. Mater. Cycles Waste Manag., 17, 369-379, 2015.
Ibarra, M. I., Recycling of thermosets and their composites in Thermosets: Structure, Properties, and Applications: Second Edition, p 639-666, 2018.
Janik, H., M. Sienkiewicz, J. Kucinska-Lipka, Polyurethanes in Handbook of Thermoset Plastics, edited by Sydney H. Goodman, and H. Dodiuk, Elsevier Science & Technology Books, 2013.
Jia, J, Z. Huang, Y. Qin, Dynamic and mechanical properties of vinyl ester/epoxy interpenetrating polymer networks, High Performance Polymers, 25, 652-657, 2013.
Kao, C. C., O. R. Ghita, K. R. Hallam, P. J. Heard, K. E. Evans, Mechanical studies of single glass fibres recycled from hydrolysis process using sub-critical water, Composites: Part A, 43, 398-406, 2012.
Kaw, A. K., Mechanics of Composite Materials, CRC Press, 1997.
Krevelen, D. W. van, K. Nijenhuis, Properties of Polymers: Their Correlation with Chemical Structure; their Numerical Estimation and Prediction from Additive Group Contributions, Elsevier Science & Technology, 2009.
Kostrzewa, M., B. Hausnerova, M. Bakar, M. Dalka, Property evaluation and structure analysis of polyurethane/epoxy graft interpenetrating polymer networks, Journal of Applied Polymer Science, 122, 1722-1730, 2011.
Kuang, X., Q. Shi, Y. Zhou, Z. Zhao, T. Wang, H. J. Qi, Dissolution of epoxy thermosets via mild alcoholysis: the mechanism and kinetics study, RSC Adv., 8, 1493-1502, 2018.
Kumar, A., R. K. Gupta, Fundamentals of Polymer Engineering, 3^{rd} edition, CRC Press, Boca Raton, F L, 2019.
Launay, H., C. M. Hansen, K. Almdal, Hansen solubility parameters for a carbon fiber/epoxy composite, Carbon, 45, 2859-2865, 2007.
Li, M., Jun Wang, Weiqing Liu, Ruifeng Liang, Hota GangaRao, Yang Li, Combined Effects of Sustained Loads and Wet-Dry Cycles on Durability of Glass Fiber Reinforced Polymer Composites, Advances in Materials Science and Engineering, v2017, Article ID 1532360, 14 pages, 2017.
Loos, A. C., G. S. Springer, Curing of epoxy matrix composites. J. Composite Materials, 17, 135-169, 1983.
Manalo, A., Ginghis M., Brahim B., Patrice C., Omar Alajarmeh, Wahid Ferdous, Ray Liang, Gangarao Hota, Comparative durability of GFRP composite reinforcing bars in concrete and in simulated concrete environments, Cement and Concrete Composites 109, 103564, 2020.
Mezzenga, R., L. Boogh, J. E. Minson, Evaluation of solubility parameters during polymerisation of amine-cured epoxy resins, Journal of Polymer Science: Part B: Polymer Physics, 38, 1883-1892, 2000.
Monte, S. J., Why titanates & zirconates may be better coupling agents than silanes for glass, aramid & carbon fiber and other inorganic and organic nano-reinforcements, ITEC in Focus: Reinforcements for Tires, Sep. 13-14, 2017, Cuyahoga Fall, OH.
Oliveux, G., L. O. Dandy, G. A. Leeke, Degradation of a model epoxy resin by solvolysis routes, Polymer Degradation and Stability, 118, 96-103, 2015.
Oliveux, G., L. O. Dandy, G. A. Leeke, Current status of recycling of fibre reinforced polymers: Review of technologies, reuse and resulting properties, Progress in Materials Science 72, 61-99, 2015b.
Parnas, R. S., A. J. Salem, A comparison of the unidirectional and radial in-plane flow of fluids through woven composite reinforcements, Polym. Compos., 14, 383-394, 1993.
Post, W., A. Susa, R. Blaauw, K. Molenveld, R. J. I. Knoop, A Review on the Potential and Limitations of Recyclable Thermosets for Structural Applications, Polymer Reviews, https://doi.org/10,080/15583724.2019.1673406, 1-30, 2019.
Qin, C. L., Niu, H. J., Bai, X. D., Ding, Y. C., The Influence of Reaction Kinetics on Polyurethane/Vinyl Ester Resin Interpenetrating Polymer Network, Polymers & Polymer Composites, 15, 329-335, 2007.
Rana, H. T., Gupta R. K, GangaRao H. and Sridhar L. N., Measurement of Moisture Diffusitivity through Layered—Silicate Nanocomposite, AIChE Journal, 51, P3249-3256, 2005.
Savins, J. G., Non-Newtonian flow through porous media, Ind. Eng. Chem., 61, 18-47, 1969.
Schiedegger, A. E., Physics of Flow Through Porous Media. 3rd ed. University of Toronto Press, Toronto, 1974.
Senet, S, Plastic Production on rise world wide but slowing in Europe, Journal de l'environment, Aug. 27, 2019.
Sperling, L. H., R. Hu, Interpenetrating Polymer Networks, in Polymer Blends Handbook, 2^{nd} ed., Vol. 1 (L. A. Utracki and C. A. Wilkie Eds.), Springer, Dordrecht, Netherlands, 2014, pp. 677-724.
Springer, G. S., Resin flow during the cure of fiber reinforced composites. J. Composite Materials, 16, 400-410, 1982.
Suresh, G., L. S. Jayakumari, Analyzing the mechanical behavior of E-glass fibre-reinforced interpenetrating polymer network composite pipe, Journal of Composite Materials, 50, 3053-3061, 2015.
Thomason, J. L., Glass fibre sizing: A review, Composites Part A, 127, 105619, 2019.
Vadlamani, D., Gangarao, Hota V. S., Strain energy density based failure criterion for GFRP composites, International SAMPE Symposium and Exhibition (Proceedings), v 52, 2007, SAMPE '07: M and P—From Coast to Coast and Around the World; Conference Proceedings.
Vallee, M., G. Tersac, N. Destais-Orvoen, G. Durand, Chemical recycling of class a surface quality sheet-molding composites, Ind. Eng. Chem. Res., 43, 6317-6324, 2004. van Oosterom, S., Allen, T.; Battley, M.; Bickerton, S., An objective comparison of common vacuum assisted resin infusion processes, Composites Part A: Applied Science and Manufacturing, 125, 105528, 2019.
Varganici, C., L. Rosu, D. Rosu, B. C. Simionescu, Miscibility studies of some semi interpenetrating polymer networks based on an aromatic polyurethane and epoxy resin, Composites: Part B, 50, 273-278 (2013).
Vijay, P. V., H. V. S. GangaRao and J. R. Basto. “Recycled Polymer Composites and Their End Use”, Proceedings, International Symposium, SAMPE, 2003, Anaheim, CA.
Yang, P., Q. Zhou, X. Yuan, J. M. N. van Kasteren, Y-Z. Wang, Highly efficient solvolysis of epoxy resin using poly(ethylene glycol)/NaOH systems, Polymer Degradation and Stability 97, 1101-1106, 2012.
Pascault, J.-P.; Williams, R. J. J. Source: Thermosets: Structure, Properties, and Applications: Second Edition, Elsevier, p 3-34, 2018.

It will be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

It is further to be understood that all values are approximate, and are provided for description.

All patents, applications, publications, test methods, literature, and other materials cited herein are incorporated by reference. If there is a discrepancy between (a) the incorporated by reference patents, applications, publications, test methods, literature, and other materials, and (b) the present application, then the present application's specification, figures, and claims control the meaning of any terms and the scope of the inventions set forth herein.

What is claimed is:

1. A method for forming a recycled or remanufactured composite material comprising:
softening of a fiber-reinforced thermosetting composite by subjecting said fiber-reinforced thermosetting composite to a partial solvolysis, and optionally using a catalyst, and optionally using elevated temperature and elevated pressure conditions over a period of time, to form a softened fiber-reinforced thermosetting composite, and optionally washing said softened fiber-reinforced thermosetting composite with water or other solvent;
reshaping/resizing said softened fiber-reinforced thermosetting composite to form a reshaped softened fiber-reinforced thermosetting composite, and optionally drying said reshaped softened fiber-reinforced thermosetting composite; and
infusing said reshaped softened fiber-reinforced thermosetting composite, with a virgin thermosetting resin to form a recycled or a remanufactured composite material having an interpenetrated polymer network.

2. The method of claim 2 wherein said partial solvolysis is carried out using a solvent.

3. The method of claim 2 wherein said solvent is one selected from the group consisting of water, an alcohol, a glycol, acetone, N-Methyl-2-pyrrolidone, and an acid, or a combination of two or more thereof.

4. The method of claim 3 wherein said alcohol is one selected from the group consisting of a benzyl alcohol, a methanol, an ethanol, and a propanol, or a combination of two or more thereof.

5. The method of claim 1 wherein said virgin thermosetting resin is polyurethane or another resin.

6. The method of claim 1 including employing a pre-softening step comprising employing elevated pressures and temperatures for grafting or synthesizing by sequential or simultaneous polymerization two immiscible polymers to manufacture cross-linking polymer systems for forming interpenetrating polymer networks.

7. The method of claim 1 including wherein said solvolysis step includes subjecting said fiber-reinforced thermosetting composite to said elevated temperature that is from greater than 20 degrees Centigrade up to and greater than 400 degrees Centigrade, wherein said elevated pressure is from greater than atmospheric pressure to greater than 3000 psi, and said time period that is from two seconds to greater than 24 hours.

8. The method of claim 1 including infusing said reshaped softened fiber-reinforced thermosetting composite using glass fiber wrapping or other fibers in place of said virgin thermosetting resin.

9. The method of claim 1 including prior to subjecting said fiber-reinforced thermosetting composite to said partial solvolysis step, placing holes or spaces on a surface or into said fiber-reinforced thermosetting composite.

10. The method of claim 1 including wherein said infusing of said reshaped softened fiber-reinforced thermosetting composite is accomplished using a vacuum assisted resin infusion process or high pressure infusion process.

11. A recycled or remanufactured composite material manufactured by the steps comprising:
softening of a fiber-reinforced thermosetting composite by subjecting said fiber-reinforced thermosetting composite to a partial solvolysis, and optionally using a catalyst, and optionally under elevated temperature and pressure conditions over a period of time, to form a softened fiber-reinforced thermosetting composite, and optionally washing and/or drying and/or segregating a residue thru sieving of said softened fiber-reinforced thermosetting composite with water or another solvent;
reshaping/resizing said softened fiber-reinforced thermosetting composite to form a reshaped softened fiber-reinforced thermosetting composite, and optionally drying said reshaped softened fiber-reinforced thermosetting composite; and
infusing said reshaped softened fiber-reinforced thermosetting composite with a virgin thermosetting resin to achieve cross links thru said softened thermosetting composite and to form a recycled or a remanufactured composite material having an interpenetrated polymer network.

12. The recycled or remanufactured composite material of claim 11 wherein said partial solvolysis is carried out using a solvent and utilizing said solvent to create interpenetrating networks within softened polymers.

13. The recycled or remanufactured composite material of claim 11 wherein said solvent is one selected from the group consisting of water, an alcohol, a glycol, acetone, N-Methyl-2-pyrrolidone, and an acid, or a combination of two or more thereof.

14. The recycled or remanufactured composite material of claim 11 wherein said alcohol is one selected from the group consisting of a benzyl alcohol, a methanol, an ethanol, and a propanol, or a combination of two or more thereof.

15. The recycled or remanufactured composite material of claim 11 wherein sad virgin thermosetting resin is polyurethane or another resin.

16. The recycled or remanufactured composite material of claim 11 including wherein said solvolysis step includes subjecting said fiber-reinforced thermosetting composite to said elevated temperature that is greater than room temperature and up to and greater than 400 degrees Centigrade and said elevated pressure is from greater than atmospheric pressure to greater than 3,000 psi and said time period that is from two seconds to greater than 24 hours.

17. The recycled or remanufactured composite material of claim 11 including infusing said reshaped softened fiber-reinforced thermosetting composite using a glass or other fiber wrapping in place of said virgin thermosetting resin.

18. The recycled or remanufactured composite material of claim 11 including infusing of said reshaped softened fiber-reinforced thermosetting composite is accomplished using a vacuum assisted or high pressure resin infusion process.
